(19) United States
(12) Patent Application Publication
(10) Pub. No.: US 2015/0215656 A1
(43) Pub. Date: Jul. 30, 2015

(54) CONTENT MANAGEMENT APPARATUS AND METHOD, AND STORAGE MEDIUM

(71) Applicant: HITACHI, LTD., Chiyoda-ku, Tokyo (JP)

(72) Inventors: Waskito Pulung, Tokyo (JP); Masashi Iwaki, Tokyo (JP); Yoshitaka Sato, Tokyo (JP)

(21) Appl. No.: 14/426,447

(22) PCT Filed: Feb. 6, 2013
(86) PCT No.: PCT/JP2013/052752

§ 371 Date: Mar. 6, 2015

(51) Int. Cl. H04N 21/231; H04N 21/239

(52) U.S. Cl. CPC H04N 21/23106; H04N 21/2393; H04N 21/23113

(57) ABSTRACT

Proposed are a content management apparatus and method, and a storage medium capable of improving the utilization efficiency of a cache in a content management system. In a content management apparatus which manages one or more contents to be delivered in which data is stored in a storage apparatus and, in accordance with a delivery request from a client, delivers the delivery-requested content to the requesting client, a viewing history of the content of each user using each of the clients and a content characteristic of each content which is extracted from information associated with the content are respectively managed, and the content in which data is to be stored in the cache and the content in which data is to be purged from the cache are determined based on the user characteristic of each user and the content characteristic of each content.

### TECHNICAL FIELD

The present invention generally relates to a content management apparatus and method, and a storage medium, and specifically relates to a content management technology for providing on-demand services of video contents and the like.

### BACKGROUND ART

In recent years, a VOD (Video On Demand) service that offers high-quality video contents is spreading rapidly pursuant to the reinforcement of network communication lines and the increase of compatible devices. A content delivery system that provides the VOD service uses the main storage (semiconductor memory) of the delivery server as a cache in order to efficiently deliver large quantities of contents to numerous clients. By storing the contents in the cache, the contents can be delivered faster in comparison to the case of reading the contents from a hard disk device or other storage apparatuses.

However, since the capacity of a cache is limited, the cache management method of efficiently using the cache is important. As this kind of cache management method, PTL 1 discloses a technology where, when there is no area to store the content upon storing the content to be delivered in the cache server, the frequency of playback requests for each content that was previously stored in the cache server is calculated, and the content to be purged from the cache server is determined with the calculated frequency of playback requests as a reference.

### CITATION LIST

### Patent Literature

[PTL 1] Japanese Patent Application Publication No. 2010-103608

### SUMMARY OF INVENTION

### Technical Problem

Meanwhile, the type of technology disclosed in PTL 1 includes a scheme of determining the content to be purged from the cache server by using only the content characteristic. Here, the term “content characteristic” refers to the characteristic that is extracted from information associated with the content, and, for example, considered may be the access trend that is extracted from the cumulative access number of the content, information on whether the content is stored in the cache in accordance with the cache status, and popularity based on the number of viewers of the content. The technology disclosed in PTL 1 uses the anticipated playback request frequency, which is the expected value of playback for each content, as the content characteristic.

Nevertheless, when only the content characteristic is used as the criteria, the appropriate content storage status cannot be selected since the information is insufficient. For example, with the type of technology disclosed in PTL 1, the anticipated playback request frequency, which is expected value of playback of the content, is calculated by dividing the number of people who have not yet viewed the content by the elapsed time from the start of delivery of the content, and the content to be stored in the cache is selected based on the foregoing calculation result.

That is, the anticipated playback request frequency becomes higher and the probability of the content being stored in the cache will increase as the number of people who have not viewed the content is greater, or as the elapsed time from the start of delivery of the content is shorter. To put it differently, as the elapsed time from the start of delivery becomes longer, even when the popularity of the content increases and the number of viewers who have yet to watch the content decreases, the influence on the anticipated playback request frequency will become small, and the content will not be stored in the cache even though it should be stored in the cache.

Moreover, when the number of contents provided by the VOD service provider increases, the number of contents viewed by few people will increase. Since the number of people who have not viewed these contents is great, the anticipated playback request frequency will increase, and these contents are stored in the cache when a playback request is received. Nevertheless, since not all of these contents are popular, some contents are stored in the cache but not accessed, and will eventually be purged from the cache. If the number of these contents increases, wasteful use of the cache will increase, and can no longer be ignored.

The present invention was devised in consideration of the foregoing points, and the objective of the present invention is to improve utilization efficiency of the cache in a content management system.

### Solution to Problem

In order to achieve the foregoing objective, the present invention provides a content management apparatus which manages one or more contents to be delivered in which data is stored in a storage apparatus and, in accordance with a delivery request from a client, delivers the delivery-requested content to the requesting client, comprising a cache for temporarily storing data of the content and a control unit for determining the content in which data is to be stored in the cache and the content in which data is to be purged from the cache based on a user characteristic of each user which is obtained based on a viewing history of the content of each user using each of the clients, and a content characteristic of each of the contents which is extracted from information associated with the content.

Moreover, the present invention additionally provides a content management method of managing one or more contents to be delivered in a content management apparatus which manages one or more contents to be delivered in which data is stored in a storage apparatus and, in accordance with a delivery request from a client, delivers the delivery-requested content to the requesting client, wherein the content management apparatus includes a cache for temporarily storing data of the content, and a control unit for determining the content in which data is to be stored in the cache and the content in which data is to be purged from the cache, and wherein the content management method comprises a first step of the control unit respectively managing a viewing history of the content of each user using each of the clients, and a content characteristic of each of the contents which is extracted from information associated with the content, and a second step of the control unit determining the content in which data is to be stored in the cache and the content in which data is to be purged from the cache based on the user characteristic of each user and the content characteristic of each of the contents.

The present invention additionally provides a storage medium storing a program to be loaded in a content management apparatus which manages one or more contents to be delivered in which data is stored in a storage apparatus and, in accordance with a delivery request from a client (terminal), delivers the delivery-requested content to the requesting client, wherein the content management apparatus includes a cache for temporarily storing data of the content, and a control unit for determining the content in which data is to be stored in the cache and the content in which data is to be purged from the cache, and wherein the program causes the control unit to execute a first step of respectively managing a viewing history of the content of each user using each of the clients, and a content characteristic of each of the contents which is extracted from information associated with the content, and a second step of determining the content in which data is to be stored in the cache and the content in which data is to be purged from the cache based on the user characteristic of each user and the content characteristic of each of the contents.

According to the content management apparatus and method, and the storage medium of the present invention, a more appropriate storage status can be selected for each content since the content storage status (whether to store data in the cache) is determined based on the user characteristic of individual users and the content characteristic of individual contents.

### Advantageous Effects of Invention

According to the present invention, since it is possible to selectively store the appropriate contents data in the cache, the utilization efficiency of the cache can be improved.

### BRIEF DESCRIPTION OF DRAWINGS

FIG. 1 is a block diagram showing an overall configuration of the content delivery system according to the first embodiment.

FIG. 2 is an example of the content management table.

FIG. 3 is an example of the content access trend management table.

FIG. 4 is an example of the content viewing history management table.

FIG. 5 is an example of the user index management table.

FIG. 6 is a conceptual diagram showing the flow of the content delivery processing in the content delivery system.

FIG. 7 is a conceptual diagram showing the flow of updating the respective management tables in the content delivery processing.

FIG. 8 is a flowchart showing the processing routine of the content playback processing.

FIG. 9 is a flowchart showing the processing routine of the content delivery processing.

FIG. 10 is a flowchart showing the processing routine of the content management processing.

FIG. 11 is a flowchart showing the processing routine of the content viewing history table update processing.

FIG. 12 is a flowchart showing the processing routine of the content storage status determination processing.

FIG. 13 is a flowchart showing the processing routine of the cache storage preparation processing.

FIG. 14 is a flowchart showing the processing routine of the cache purge processing.

FIG. 15 is a flowchart showing the processing routine of the user characteristic update processing.

FIG. 16 is a block diagram showing an overall configuration of the content delivery system according to the second embodiment.

FIG. 17 is an example of the storage performance management table.

FIG. 18 is a flowchart showing the processing routine of the cache purge processing according to the second embodiment.

FIG. 19 is a flowchart showing the processing routine of the content distribution processing.

FIG. 20 is a block diagram showing an overall configuration of the content delivery system according to the third embodiment.

FIG. 21 is a conceptual diagram showing a configuration of the content viewing history management table according to the third embodiment.

FIG. 22 is an example of the content peak access period management table.

FIG. 23 is a histogram explaining the detection method of the peak access period of the content.

FIG. 24 is a histogram explaining the detection method of the peak access period of the content.

FIG. 25 is a flowchart showing the processing routine of the content storage status determination processing according to the third embodiment.

### DESCRIPTION OF EMBODIMENTS

An embodiment of the present invention is now explained in detail with reference to the drawings.

### (1) First Embodiment

### (1-1) Configuration of Content Delivery System According to the Present Embodiment

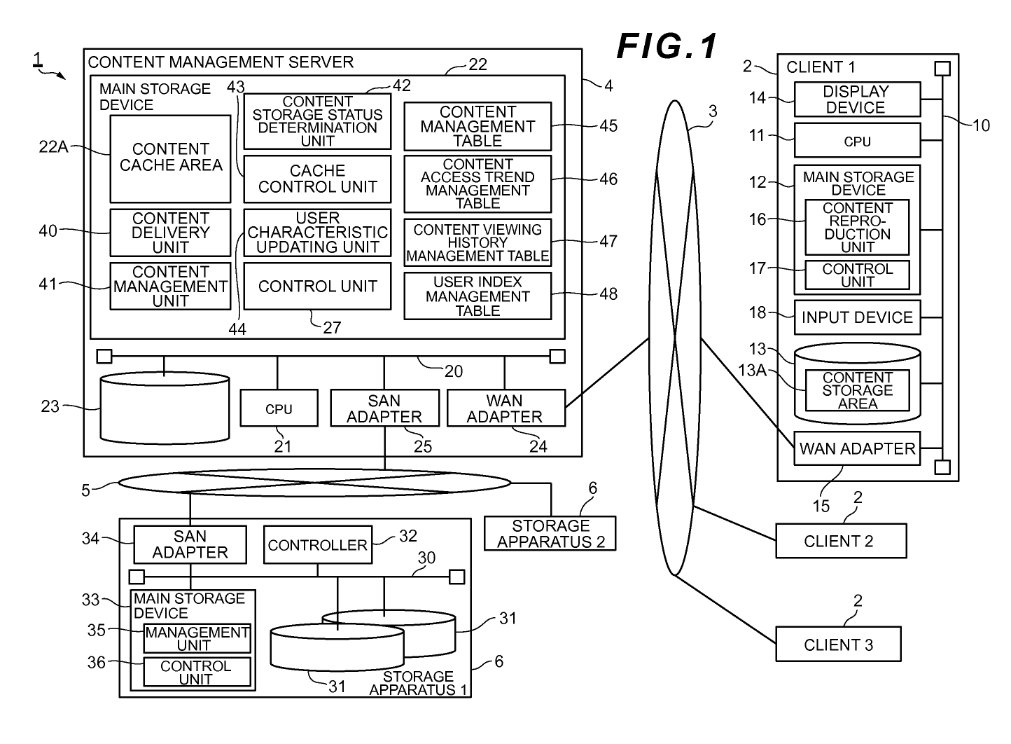

FIG. 1 shows the overall content delivery system 1 according to the present embodiment. The content delivery system 1 is configured by one or more clients 2 being connected to a content management server 4 via a WAN (Wide Area Network) 3, and the content management server 4 being connected to one or more storage apparatuses 6 via a SAN (Storage Area Network) 5.

The client 2 is a communication terminal such as a personal computer or a smartphone used by a user of a content delivery service described later, and configured by comprising a CPU (Central Processing Unit) 11, a main storage device 12, an auxiliary storage device 13, a display device 14, a WAN adapter 15 and an input device 18 which are mutually connected via a system bus 10.

The CPU 11 is a processor that governs the operational control of the overall client 2. Moreover, the main storage device 12 is configured from a semiconductor memory, and used as a work memory of the CPU 11. The auxiliary storage device 13 is configured from a hard disk device or the like, and stores various programs and various data. Various types of processing of the overall client 2 are executed as a result of the programs stored in the auxiliary storage device 13 being read into the main storage device 12 at a predetermined timing, and the CPU 11 executing these programs.

As described later, a content playback unit 16, which is a program module for playing and processing data of the content delivered from the content management server 4 (hereinafter referred to as the “content data”), and a control unit 17 including an OS (Operating System) are also read from the auxiliary storage device 13 and retained in the main storage device 12. Note that the auxiliary storage device 13 is internally provided with a content storage area 13A as a storage area for temporarily retaining the content data that was delivered from the content management server 4.

The display device 14 is configured from, for example, a liquid crystal display. Moreover, the WAN adapter 15 is an interface for connecting the client 2 to the WAN 3, and performs processing such as protocol conversion during the communication with the content management server 4 via the WAN. The input device 18 is configured from a keyboard, a mouse, a tablet or the like and is used for selecting the contents or controlling the setting of the client 2 and the content management server 4.

The content management server 4 is a server apparatus that provides a content delivery service of delivering, to the client 2, content data of video contents or the like in response to a request from that client 2. The content management server 4 is configured by comprising a CPU 21, a main storage device 22, an auxiliary storage device 23, a WAN adapter 24 and a SAN adapter 25 which are mutually connected via a system bus 20.

The CPU 21 is a processor for governing the operational control of the overall content management server 4. Moreover, the main storage device 22 is configured from a semiconductor memory, and used as a work memory of the CPU 21. The auxiliary storage device 23 is configured from a hard disk device or the like, and stores various programs and various data. Various types of processing of the overall content management server 4 are executed as a result of the programs stored in the auxiliary storage device 23 being read into the main storage device 22 at a predetermined timing, and the CPU 21 executing these programs. A control unit 27 including an OS is also read from the auxiliary storage device 23 when the content management server 4 is activated, and retained in the main storage device 22.

Note that the main storage device 22 is provided with a content cache area 22A as a storage area for temporarily storing the content data of one or more contents read from the storage apparatus 6. By storing, in the content cache area 22A, the content data of contents with a high access frequency and contents in which access is expected to increase in the future, these contents can be delivered to the client 2 more quickly.

The WAN adapter 24 is an interface for connecting the content management server 4 to the WAN 3, and performs processing such as protocol conversion during the communication with the client 2 via the WAN 3. Moreover, the SAN adapter 25 is an interface for connecting the content management server 4 to the SAN 5, and performs processing such as protocol conversion during the communication with the storage apparatus 6 via the SAN 5.

The storage apparatus 6 is a large-capacity storage device for storing and retaining various contents, and configured by comprising one or more storage devices 31, a controller 32, a main storage device 33 and a SAN adapter 34 which are mutually connected via a system bus 30.

The storage device 31 is configured from, for example, an expensive disk device such as a SAS (Serial Attached SCSI) disk, or an inexpensive disk device such as a SATA (Serial Advanced Technology Attachment) disk or an optical disk, or a semiconductor memory such as an SSD (Solid State Drive). The content data of one or more contents to be delivered is stored and retained in these storage devices 31. Moreover, a specific storage device 31 stores various programs and various data.

The controller 32 is a processor that governs the operational control of the overall storage apparatus 6. Moreover, the main storage device 33 is configured from a semiconductor memory, and used as a work memory of the controller 32. Various types of processing, such as the reading and writing of contents from and into the storage device 31, are executed as a result of the programs stored in the specific storage device 31 being read into the main storage device 33 at a predetermined timing, and the controller 32 executing these programs.

A management unit 35, which is a program module for performing the control of distributing the content data of contents to the respective storage devices 31 in the storage apparatus 6, and a control unit 36 including an OS are also read from the specific storage device 31 and stored and retained in the main storage device 33.

### (1-2) Content Management Function

The content management function according to the present embodiment that is equipped in the content management server 4 is now explained. The content delivery system 1 of the present embodiment is unique in that the content management server 4 is equipped with a content management function of determining the contents to be stored in the content cache area 22A of the main storage device 22 of the content management server 4 and the contents to be purged from the content cache area 22A based on the user characteristic of each user and the content characteristic of each content.

Here, the term “user characteristic” refers to the characteristic that is extracted from the information associated with the user and is, for example, the characteristic that is recognized from the viewing history of each user. In the present embodiment, an index value that is calculated based on the viewing history or the like of the user (hereinafter referred to as the “user index value”) is used as the user characteristic. For example, a high user index value is set to a user who has viewed numerous popular contents. The initial value of the user index value may be any numerical value (including “0”). In the case of the present embodiment, the content to be stored in the content cache area 22A of the main storage device 22 of the content management server 4 is determined based on the user index value of each user.

Moreover, the term “content characteristic” refers to the characteristic that is extracted from the information associated with the content as described above. In the case of the present embodiment, a total value of the user index values of all users who have viewed the content is used as the content characteristic. Details regarding the total value will be described later. In the case of the present embodiment, the content in which the content data is to be purged from the content cache area 22A is determined based on the content characteristic of the respective contents in which the content data is stored in the content cache area 22A of the main storage device 22.

As means for realizing the foregoing content management function of the present embodiment, as shown in FIG. 1, the main storage device 22 of the content management server 4 stores, as program modules, a content delivery unit 40, a content management unit 41, a content storage status determination unit 42, a cache control unit 43 and a user characteristic updating unit 44, and stores, as management tables, a content management table 45, a content access trend management table 46, a content viewing history management table 47 and a user index management table 48.

The content delivery unit 40 is a module for reading, from the content cache area 22A in the main storage device 22 of the content management server 4 or the storage apparatus 6, the content data of the content for which delivery was requested (hereinafter referred to as the “delivery-requested content”) by being designated in a delivery request of the content (hereinafter referred to as the “content delivery request”) sent from the client 2, and sending the read content data to the client 2 as the sender of the content delivery request.

Moreover, the content management unit 41 is a module for searching for the storage location of the content data of the delivery-requested content in response to the request from the content delivery unit 40, and notifying the storage location to the content delivery unit 40. In addition, the content storage status determination unit 42 is a module for determining the storage status of the delivery-requested content (whether the content data is to be stored in the content cache area 22A) when the content data of the delivery-requested content is not stored in the content cache area 22A of the main storage device 22.

The cache control unit 43 is a module for allocating in the content cache area 22A, when the content storage status determination unit 42 determines that the content data of the delivery-requested content is to be stored in the content cache area 22A of the main storage device 22, a storage area for storing the content data. Moreover, the user characteristic updating unit 44 is a module for updating the user index management table 48 according to the instructions from the cache control unit 43.

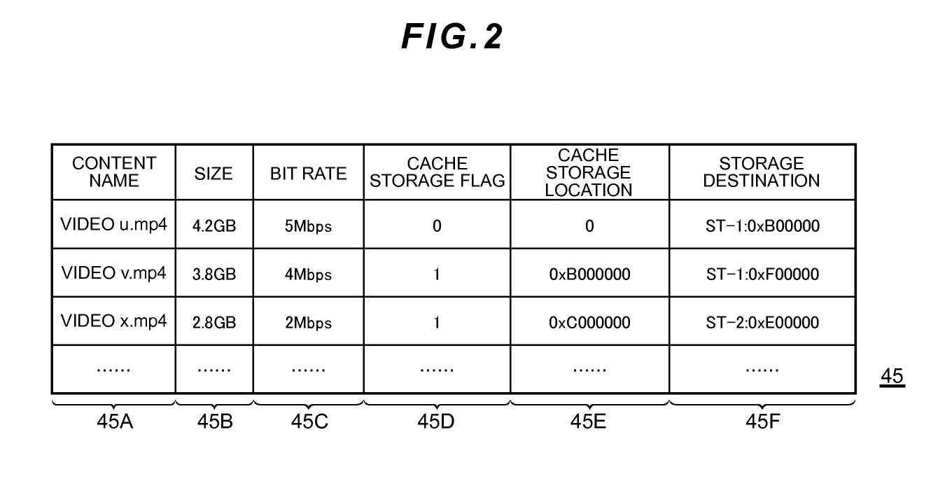

Meanwhile, the content management table 45 is a table that is used for managing the contents that can be provided from the content management server 4 to the client 2. The content management table 45 is configured from, as shown in FIG. 2, a content name column 45A, a size column 45B, a bit rate column 45C, a cache storage flag column 45D, a cache storage location column 45E and a storage destination column 45F.

The content name column 45A stores the name of the respective contents (hereinafter referred to as the “content name”) that are being managed by the content management server 4, and the size column 45B stores the file size of the corresponding content. Moreover, the bit rate column 45C stores the data transfer rate upon transferring the content data of the corresponding content to the client 2.

The cache storage flag column 45D stores a flag (hereinafter referred to as the “cache storage flag”) indicating whether the content data of the content is stored in the content cache area 22A of the main storage device 22. In the foregoing case, the cache storage flag is set to “1” when the content data of the corresponding content is stored in the content cache area 22A, and set to “0” when the content data is not stored in the content cache area 22A.

When the content data of the corresponding content is stored in the content cache area 22A of the main storage device 22, the cache storage location column 45E stores the address (hereinafter referred to as the “cache storage location address”) in the content cache area 22A where the content data is stored. Moreover, the storage destination column 45F stores the address (hereinafter referred to as the “storage destination address”) configured from the apparatus ID of the storage apparatus 6 that is storing the content data of the corresponding content, and the address location in the storage apparatus 6 where the content data is being stored.

Accordingly, FIG. 2 shows a case where, for instance, the content named “video u.mp4” has a data size of “4.2 GB” and a data transfer rate of “5 Mbps”, and the content data is not stored in the content cache area 22A of the main storage device 22, and is stored at the address location of 0xB00000” in the storage apparatus 6 named “ST-1”.

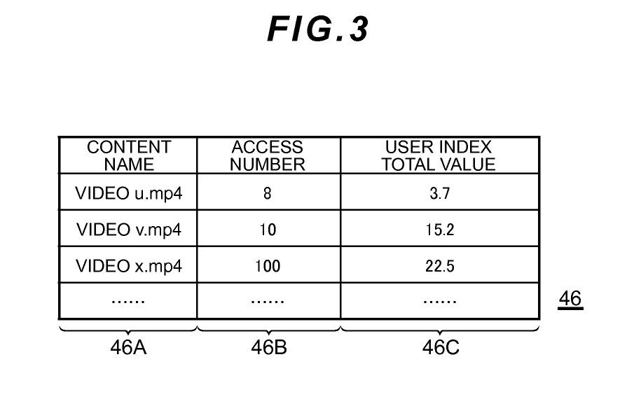

The content access trend management table 46 is a table that is used for managing the access number of each content that is being managed by the content management server 4, and the total value of the user index value of each content (hereinafter referred to as the “user index total value”). The content access trend management table 46 is configured from, as shown in FIG. 3, a content name column 46A, an access number column 46B and a user index total value column 46C.

The content name column 46A stores the content name of each content that is being managed by the content management server 4, and the access number column 46B stores the access number to the corresponding content within a prescribed period. Here, the term “prescribed period” refers to the time that was set by the system administrator of the content management system 1. Moreover, the access number may be subject to reset processing at a predetermined timing so the contents that previously had a high access number will not be perpetually stored in the cache. As a method of performing the reset processing, for instance, adopting may be a method of reducing the access number in half for each lapse of a prescribed period.

Moreover, the user index total value column 46C stores the total value (user index total value) of user index values of all users who viewed the corresponding content. Note that, in the ensuing explanation, while the user index total value is explained as the average value of the user index values, other total values may also be applied. The trend of users who have viewed the content can be analyzed by managing the user index total value of each content.

Accordingly, FIG. 3 shows that the content named “video u.mp4” has an access number of “8” accesses within a prescribed period and the average value of the user index value (user index total value) is “3.7”, the content named “video v.mp4” has an access number of “10” accesses within a prescribed period and the user index total value is “15.2”, and the content named “video x.mp4” has an access number of “100” times within a prescribed period and the user index total value is “22.5”.

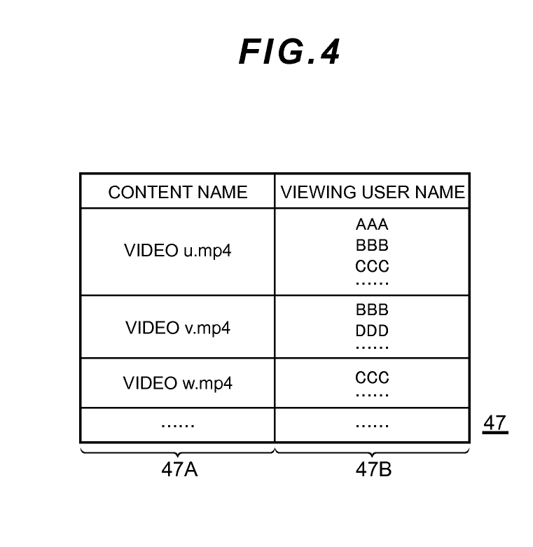

The content viewing history management table 47 is a table that is used for managing the users who viewed the respective contents in which the content data is stored in the content cache area 22A of the main storage device 22, and is configured from, as shown in FIG. 4, a content name column 47A and a viewing user name column 47B.

The content name column 47A stores the content name of the respective contents in which the content data is stored in the content cache area 22A, and the viewing user name column 47B stores the user name of the users who have previously viewed the corresponding content. Each time a user sends, to the content management server 4, a content delivery request designating a content that has not yet been viewed by that user, the user name of that user is additionally registered in the viewing user name column 47B of the entry (line) of the content in the content viewing history management table 47.

Accordingly, FIG. 4 shows that the content named “video u.mp4” has been previously viewed by the respective viewers having the user name of “AAA”, “BBB”, “CCC”, . . . , the content named “video v.mp4” has been previously viewed by the respective viewers having the user name of “BBB”, “DDD”, . . . , and the content named “video w.mp4” has been previously viewed by the respective viewers having the user name of “CCC”, . . . .

Note that, as described later, when the content data of the content is purged from the content cache area 22A, the entry corresponding to the content is deleted from the content viewing history management table 47 or that entry is deemed to be an empty entry.

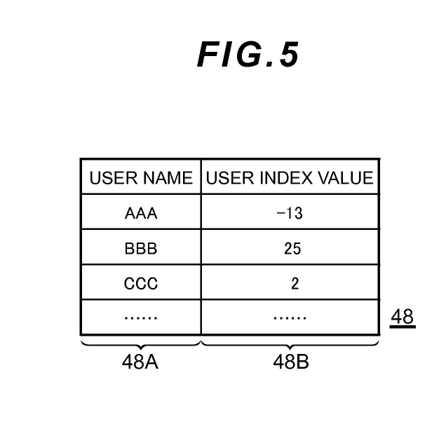

The user index management table 48 is a table that is used for managing the user index value of each user. The user index management table 48 is configured from, as shown in FIG. 5, a user name column 48A and a user index value column 48B. The user name column 48A stores the user name of the respective users that have been registered, and the user index value column 48B stores the user index value of the corresponding user.

Accordingly, FIG. 5 shows that the user index value of the user named “AAA” is “−13”, the user index value of the user named “BBB” is “25”, and the user index value of the user named “CCC” is “2”.

By the way, the term “user index value” relates to the popularity of the content that is being viewed by that user as described above. The expression “popularity of the content” refers to the frequency that a delivery request is sent from the user for the content, and, in comparison with the other contents, it is deemed that the content is popular when the frequency is higher and it is deemed that the content is unpopular when the frequency is lower.

As described above, the user index value is used for determining the storage status of the delivery-requested content (whether the content data is to be stored in the content cache area of the main storage device 22) when the content data of the delivery-requested content is not stored in the content cache area 22A of the main storage device 22 of the content management server 4. As described later, the user index value is updated when the content is purged from the content cache area 22A of the main storage device 22 (this process is hereinafter referred to as the “content purging” as appropriate).

### (1-3) Flow of Content Delivery Processing

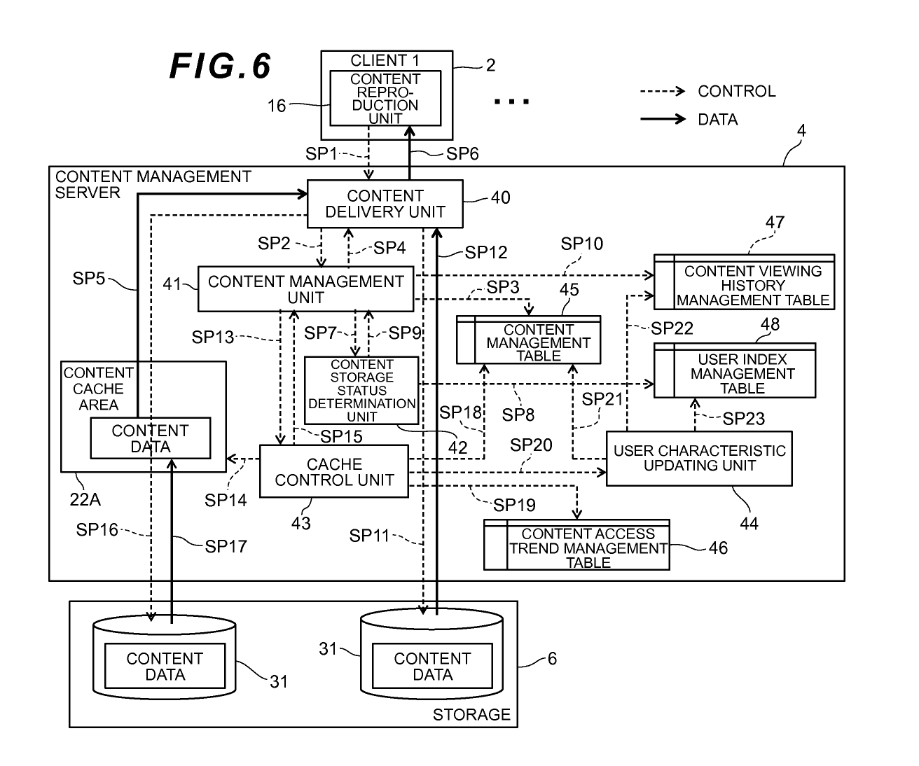

FIG. 6 shows the flow of processing and content data in the content management server 4 when the user operates the client 2 and requests the content management server 4 to deliver the intended content. In the ensuing explanation, while the processing subject of the various types of processing is explained as a “module ( . . . unit)”, in reality, it goes without saying that the processing is executed by the CPU 11 (FIG. 1) of the client 2 or the CPU 21 (FIG. 1) of the content management server 4 based on the module (program or object).

Foremost, when the user performs an operation (hereinafter referred to as the “content viewing operation”) to the client 2 for viewing the intended content, a corresponding content delivery request is sent from the content playback unit 16 of the client 2 to the content management server 4 (SP1).

When the content delivery unit 40 of the content management server 4 receives the foregoing content delivery request, the content delivery unit 40 makes an inquiry to the content management unit 41 regarding the storage location of the content data of the delivery-requested content that is designated in the content delivery request (SP2).

The content management unit 41 refers to the content management table 45 in response to the inquiry (SP3), and determines whether the content data of the delivery-requested content is stored in the content cache area 22A of the main storage device 22. When the delivery-requested content is stored in the content cache area 22A, the content management unit 41 reads, from the content management table 45, the storage location (cache storage location address) of the content data of the delivery-requested content in the content cache area 22A (SP3), and notifies the read cache storage location address to the content delivery unit 40 (SP4).

Consequently, the content delivery unit 40 reads the content data of the delivery-requested content from the cache storage location address, which was notified from the content management unit 41, in the content cache area 22A (SP5), and sends the read content data to the client 2 (SP6).

Meanwhile, when the content data of the delivery-requested content is not stored in the content cache area 22A of the main storage device 22, the content management unit 41 instructs the content storage status determination unit 42 to determine the storage status of the delivery-requested content (SP7).

When the content storage status determination unit 42 receives the foregoing instruction, the content storage status determination unit 42 acquires, from the user index management table 48, the user index value of the user who requested the delivery of the delivery-requested content (hereinafter referred to as the “delivery-requesting user”) (SP8), and determines whether the content data of the delivery-requested content is to be stored in the content cache area 22A of the main storage device 22 based on the acquired user index value.

For example, when the user index value acquired in step SP8 is not greater than a predetermined user index threshold, the content storage status determination unit 42 determines that the content data of the delivery-requested content will not be stored in the content cache area 22A, and notifies the determination result to the content management unit 41 (SP9).

In the foregoing case, the content management unit 41 acquires, from the content management table 45, the storage location (storage destination address) of the content data of the delivery-requested content (SP3). Moreover, the content management unit 41 additionally registers the user name of the user who requested the delivery of the delivery-requested content in the viewing user name column 47B (FIG. 4) of the entry corresponding to the delivery-requested content of the content viewing history management table 47 (SP10), and subsequently notifies the storage destination address, which was acquired in the manner described above, to the content delivery unit 40 (SP3).

When the storage destination address is notified from the content management unit 41, the content delivery unit 40 sends a read request to the storage apparatus 6 storing the content data for reading the content data of the delivery-requested content (SP11). Moreover, when the content delivery unit 40 receives the content data of the delivery-requested content that is sent from the storage apparatus 6 in response to the read request, the content delivery unit 40 transfers the received content data of the delivery-requested content to the client 2 as the sender of the content delivery request (SP12, SP6).

Meanwhile, when the user index value acquired in step SP8 is greater than the user index threshold in step SP9, the content storage status determination unit 42 determines that the content data of the delivery-requested content will be stored in the content cache area 22A of the main storage device 22, and notifies the determination result to the content management unit 41.

In the foregoing case, the content management unit 41 instructs the cache control unit 43 to allocate a storage area in the content cache area 22A for storing the content data of the delivery-requested content (SP13).

When the cache control unit 43 receives the foregoing instruction, the cache control unit 43 confirms whether there is an unused area for storing the content data of the delivery-requested content (SP14). When the cache control unit 43 determines that there is an unused area for storing the content data of the delivery-requested content, the cache control unit 43 allocates that unused area and subsequently notifies the content management unit 41 to such effect (SP15).

When the content management unit 41 receives a notice to the effect that there is an unused area for storing the delivery-requested content, the content management unit 41 notifies the content delivery unit 40 to such effect (SP4). Moreover, when the content delivery unit 40 receives the foregoing notice, the content delivery unit 40 sends a read request to the corresponding storage apparatus 6 for reading the content data of the delivery-requested content based on the storage location (storage destination address) of the content data of the delivery-requested content that was notified from the content management unit 41 in advance as described above (SP16).

The storage apparatus 6 that received the foregoing read request reads, from the storage device 31, the content data of the delivery-requested content designated in the read request, and sends the read content data to the content management server 4 (SP17). Consequently, the content data is thereafter sequentially written into the unused area in the content cache area 22A of the main storage device 22 that was allocated by the cache control unit 43, concurrently read from the content cache area 22A by the content delivery unit 40 (SP5), and sent to the client 2 as the sender of the content delivery request (SP6).

Meanwhile, when the cache control unit 43 determines, during the processing of step SP14, that there is no unused area in the content cache area 22A of the main storage device 22 for storing the content data of the delivery-requested content, the cache control unit 43 refers to the content management table 45 and the content access trend management table (SP18, SP19), and determines the content in which the content data is to be purged from the content cache area 22A (hereinafter referred to as the “content to be purged”) based on the content characteristic of the respective contents stored in the content cache area 22A of the main storage device 22.

Note that, as the method of determining the content to be purged, algorithms such as LRU (Least Recently Used) where the content in which the date/time of last access is the oldest is determined to be the content to be purged or LFU (Least Frequently Used) where the content with the lowest access number is determined to be the content to be purged, or other algorithms may be broadly applied. For example, when LFU is adopted as the method of determining the content to be purged, the cache control unit refers to the content access trend management table and determines the content with the lowest access number to be the content to be purged. In the ensuing explanation, let it be assumed that LFU has been adopted as the method of determining the content to be purged.

After the cache control unit 43 determines the content to be purged as described above, the cache control unit 43 purges (deletes) the content data of the content to be purged from the content cache area 22A of the main storage device 22 (SP14), and additionally notifies the content name of the content to be purged to the user characteristic updating unit 44 (SP20).

When the user characteristic updating unit 44 receives the foregoing notice, the user characteristic updating unit 44 refers to the content viewing history management table 47 (SP22), and updates the user index value of the respective users stored in the user index management table 48 based on the viewing history of the content by each of the corresponding users (SP23).

Specifically, the user-specified updating unit 44 updates the user index management table 48 so as to change the user index value of the users who have previously viewed the content to be purged to a value obtained by subtracting a predetermined number (“2” in this example) therefrom, and change the user index value of the users who have viewed, or will view, any of the contents remaining in the content cache area 22A of the main storage device 22 to a value obtained by adding a predetermined number (“1” in this example) thereto.

### (1-4) Flow of Updating Respective Management Tables

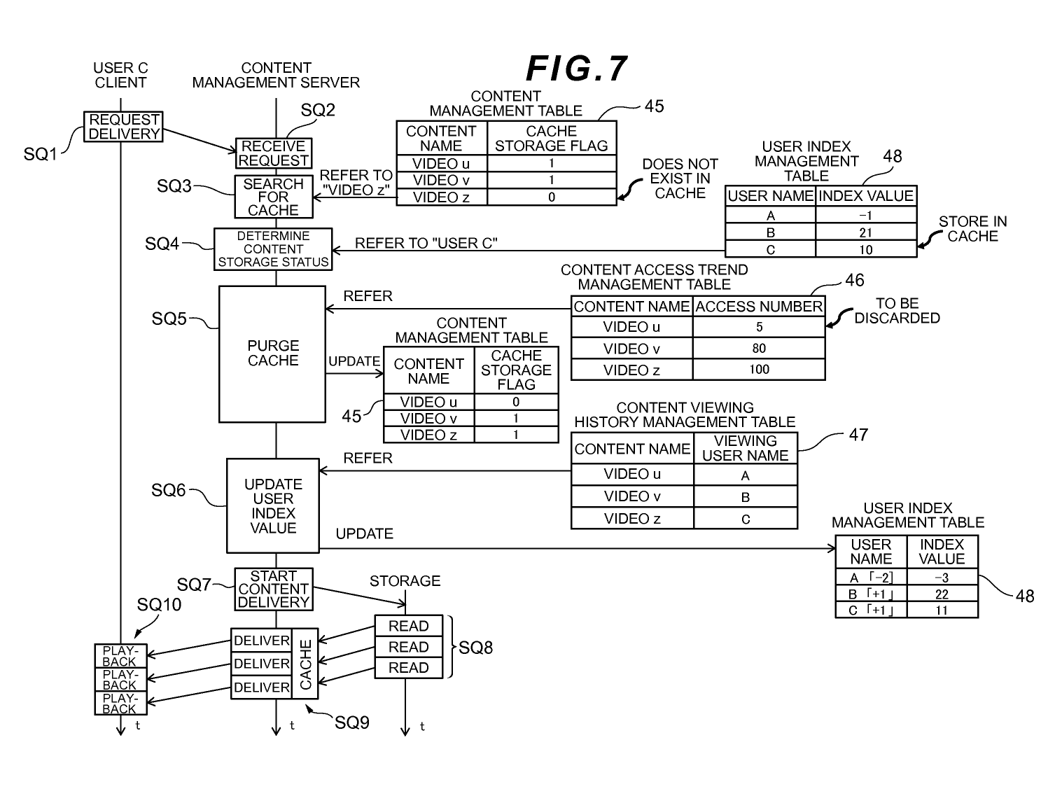

The flow of update processing of the respective management tables that is performed in the foregoing content delivery processing is now explained. FIG. 7 shows the flow of updating the respective management tables during the content delivery processing.

Note that FIG. 7 shows an example where a content delivery request designating the content named “video z” is sent to the content management server 4 from the client 2 that is being used by a user named “user C”, and a case of updating the user index value of the respective users that is performed when the content data of “video z” is to be stored in the content cache area 22A of the main storage device 22, and the purge processing of consequently purging the content data of one of the contents from the content cache area 22A is explained below.

Foremost, the delivery request sequence SQ1 is executed according to the operation of “user C”, and a content delivery request designating “video z” is sent from the client 2 to the content management server 4.

On the side of the content management server 4, upon receiving this content delivery request, the content delivery unit 40 executes the request reception sequence SQ2, and the content delivery request reception processing is executed.

In the subsequent cache search sequence SQ3, the content management unit 41 searches whether the content data of “video z” is stored in the content cache area 22A of the main storage device 22. Specifically, in this cache search sequence SQ3, the content management unit 41 refers to the cache storage flag column 45D (FIG. 2) of the entry (line) corresponding to “video z” of the content management table 45, and determines whether the value of the cache storage location flag stored in the cache storage flag column 45D is “0”. In this example, since the cache storage location flag is “0”, the content management unit 41 recognizes that the content data of the content named “video z” is not stored in the content cache area 22A of the main storage device 22. Consequently, the content management unit 41 instructs the content storage status determination unit 42 to determine the storage status of the delivery-requested content.

When the foregoing instruction is given to the content storage status determination unit 42, the content storage status determination sequence SQ4 is executed, and the content storage status determination unit 42 reads the user index value of “user C” from the user index management table 48, and determines the storage status of the content named “video z” based on the read user index value. When the user index threshold is set to “0”, since the user index value of “user C” is greater than the user index threshold, it is determined that the content named “video z” will be stored in the content cache area 22A of the main storage device 22. Subsequently, this determination result is notified to the content management unit 41.

When the content management unit 41 receives the foregoing notice, the content management unit 41 instructs the cache control unit 43 to allocate, in the content cache area 22A of the main storage device 22, a storage area for storing the content data of the delivery-requested content.

When the foregoing instruction is given to the cache control unit 43, the cache purge sequence SQ5 is executed, and the cache control unit 43 refers to the content access trend management table 46 and determines the content to be purged, and purges the content data of the content to be purged from the content cache area 22A of the main storage device 22. In the example of FIG. 7, since the access number of “video u” is the smallest, the content data of “video u” is purged from the content cache area 22A of the main storage device 22. Moreover, the cache control unit 43 thereafter changes the cache storage flag of “video u” in the content management table 45 to “0”, and additionally changes the cache storage flag of “video z” to “1”.

In the subsequent user index value update sequence SQ6, the user characteristic updating unit 44 searches for the users who have previously viewed the content to be purged from the content viewing history management table 47, and subtracts 2 from the user index value of those users in the user index management table 48. In the example of FIG. 7, since “user A” has previous viewed “video u”, which is the content to be purged, the user index value of “user A” in the user index management table 48 is updated to be a value obtained by subtracting 2 therefrom.

Moreover, concurrently with the foregoing search, the user characteristic updating unit 44 searches for the users who have viewed, or will view, any of the contents in which the content data is stored in the content cache area 22A of the main storage device 22 from the content viewing history management table 47, and adds 1 to the user index value of those users in the user index management table 48. In the example of FIG. 7, since the content data of the contents named “video v” and “video z” is stored in the content cache area 22A of the main storage device 22 and “user B” has previously viewed “video v” and “user C” is scheduled to view “video z”, the user index values of “user B” and “user C” in the user index management table 48 are updated to be values obtained by adding 1 thereto, respectively.

In the subsequent content delivery start sequence SQ7, the content delivery unit 40 sends a read request for reading the content data of “video z” to the storage apparatus 6 storing the content data of “video z” as the delivery-requested content. Consequently, the storage apparatus 6 that received the foregoing read request reads the content data of the requested “video z” in content block units, and sends the read content data to the content management server 4 (sequence SQ8).

In the subsequent content delivery sequence SQ9, the content data sent from the storage apparatus 6 in content block units is transferred to the client 2 as the sender of the content delivery request while being stored in the content cache area 22A of the content cache area 22A of the main storage device 22. Consequently, the content playback unit 16 (FIG. 1) of the client 2 reproduces, while receiving, the content data sent from the content management server 4 in content block units (sequence SQ10).

### (1-5) Processing of Respective Program Modules Related to Content Management Function

In relation to the content management function according to the present embodiment, the specific processing contents of various types of processing that are executed by the respective modules stored in the main storage device 12 (FIG. 1) of the client 2, or the main storage device 22 of the content management server 4, are now explained.

### (1-5-1) Content Playback Processing

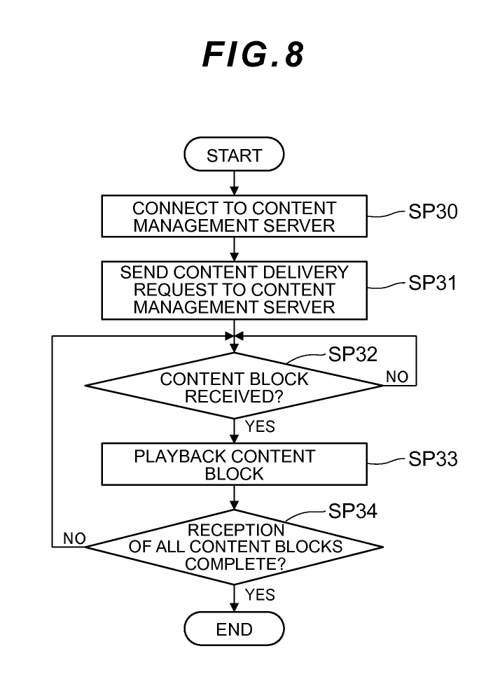

FIG. 8 shows the specific processing contents of the content playback processing that is executed by the content playback unit 16 (FIG. 1), which is stored in the main storage device 12 of the client 2, when the user performs the content viewing operation to the client 2.

When the foregoing content viewing operation is performed, the content playback unit 16 starts the content playback processing shown in FIG. 8, and foremost establishes communication with the content management server 4 according to the protocol provided by the content management server 4 (SP30).

Subsequently, the content playback unit 16 sends, to the content management server 4, a content delivery request which designates the content selected in the content viewing operation as the delivery-requested content (SP31). Moreover, the content playback unit 16 thereafter waits for the content data of the delivery-requested content to be sent from the content management server 4 (SP32).

When one data block worth of content data (hereinafter referred to as the “content block”) of the delivery-requested content is eventually sent from the content management server 4, the content playback unit 16 performs playback processing to the content block (SP33). Consequently, the image of the delivery-requested content based on the content data is displayed on the display device 14.

Subsequently, the content playback unit 16 determines whether all content blocks have been received (SP34). When the content playback unit 16 obtains a negative result in the foregoing determination, the content playback unit 16 returns to step SP32, and thereafter repeats similar processing until an affirmative result is obtained in step SP34.

When the content playback unit 16 obtains an affirmative result in step SP34 as a result of all content blocks eventually being subject to playback processing, the content playback unit 16 ends the content playback processing.

### (1-5-2) Content Delivery Processing

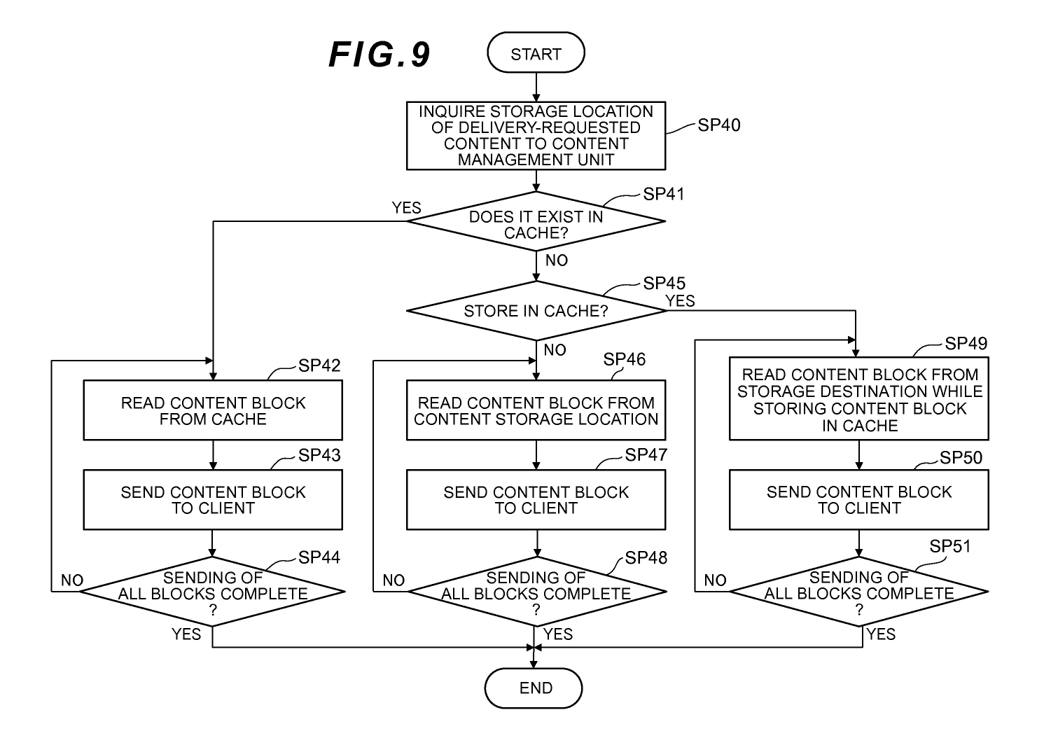

FIG. 9 shows the processing routine of the content delivery processing that is executed by the content delivery unit 40 of the content management server 4 that received the content delivery request from the client 2.

When the content delivery unit 40 receives the content delivery request, the content delivery unit 40 starts the content delivery processing shown in FIG. 9, and foremost delivers, to the content management unit 41, the user name of the user using the client 2 as the sender of the content delivery request and the content name of the delivery-requested content which are included in the received content delivery request, and makes an inquiry to the content management unit 41 regarding the storage location of the delivery-requested content (SP40).

Subsequently, the content delivery unit 40 determines whether the content data of the delivery-requested content is stored in the content cache area 22A of the main storage device 22 based on the return value from the content management unit 41 in response to the inquiry (SP41).

By the way, when the content data of the delivery-requested content is stored in the content cache area 22A of the main storage device 22, the storage location (cache storage location address) of the content data of the delivery-requested content in the content cache area 22A is notified as the foregoing return value to the content management unit 41. Consequently, the content delivery unit 40 reads one content block of the delivery-requested content from the address location of the cache storage location address in the content cache area 22A of the main storage device 22 (SP42), and sends the read content block to the client 2 (SP43).

Moreover, the content delivery unit 40 thereafter determines whether all content blocks of the delivery-requested content have been sent to the client 2 (SP44). When the content delivery unit 40 obtains a negative result in the foregoing determination, the content delivery unit 40 returns to step SP42, and thereafter returns to the processing of step SP42 to step SP44.

When the content delivery unit 40 obtains an affirmative result in step SP44 as a result of all content blocks of the delivery-requested content eventually being sent to the client 2, the content delivery unit 40 ends the content delivery processing.

Meanwhile, when the content data of the delivery-requested content is not stored in the content cache area 22A of the main storage device 22, information regarding whether the delivery-requested content is to be stored in the content cache area 22A of the main storage device 22 is notified as the foregoing return value from the content management unit 41. Consequently, the content delivery unit 40 determines whether the delivery-requested content is to be stored in the content cache area 22A of the main storage device 22 based on the return value (SP45).

When the content delivery unit 40 obtains a negative result in the foregoing determination, the content delivery unit 40 reads one content block of the delivery-requested content from the corresponding address location in the corresponding storage apparatus 6 based on the storage destination address, which is the storage location of the content data of the delivery-requested content included in the return value (SP46), and sends the read content block to the client 2 (SP47).

Moreover, the content delivery unit 40 thereafter determines whether all content blocks of the delivery-requested content have been sent to the client 2 (SP48). When the content delivery unit 40 obtains a negative result in the foregoing determination, the content delivery unit 40 returns to step SP46, and thereafter repeats the processing of step SP46 to step SP48.

When the content delivery unit 40 obtains an affirmative result in step SP48 as a result of all content blocks of the delivery-requested content eventually being sent to the client 2, the content delivery unit 40 ends the content delivery processing.

Meanwhile, when the content delivery unit 40 obtains an affirmative result in the determination of step SP45, in the same manner as step SP46, the content delivery unit 40 reads one content block of the delivery-requested content from the corresponding storage apparatus 6 (SP49), and sends the read content block to the client 2 while storing the content block in the content cache area 22A of the main storage device 22 (SP50).

Moreover, the content delivery unit 40 thereafter determines whether all content blocks of the delivery-requested content have been sent to the client 2 (SP51). When the content delivery unit 40 obtains a negative result in the foregoing determination, the content delivery unit 40 returns to step SP49, and thereafter repeats the processing of step SP49 to step SP51.

When the content delivery unit 40 obtains an affirmative result in step SP51 as a result of all content blocks of the delivery-requested content eventually being sent to the client 2, the content delivery unit 40 ends the content delivery processing.

### (1-5-3) Content Management Processing

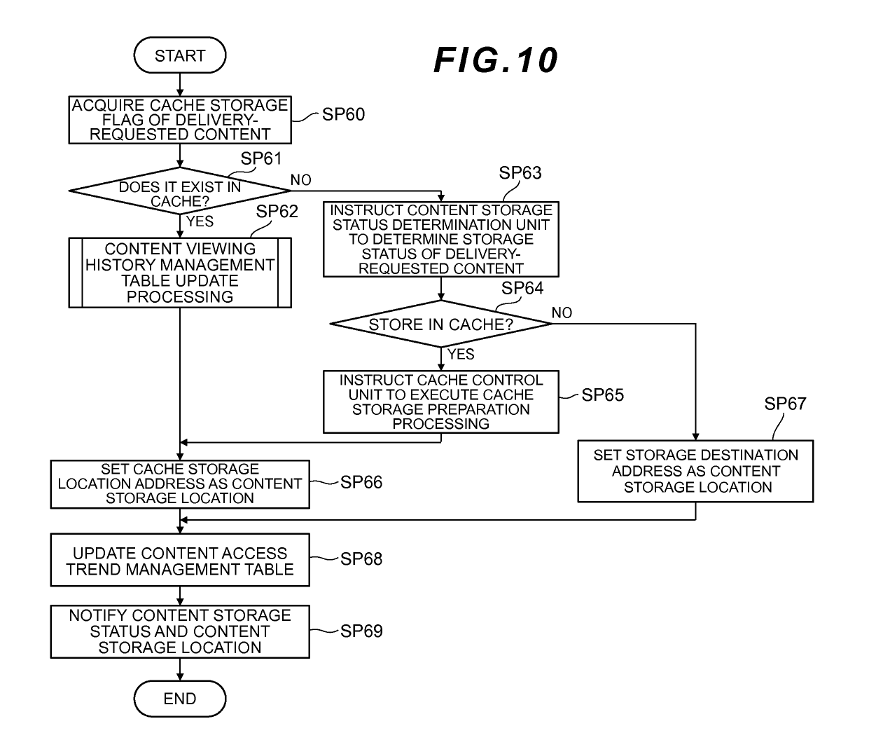

FIG. 10 shows the processing routine of the content management processing that is executed by the content management unit 41 that received an inquiry from the content delivery unit 40 regarding the storage location of the delivery-requested content. In accordance with the processing routine shown in FIG. 10, the content management unit 41 searches for the storage location of the content data of the delivery-requested content, sets the storage location in the content cache area 22A of the main storage device 22 as needed, and notifies the detected or set storage location of the content data of the delivery-requested content to the content delivery unit 40.

In reality, when the content management unit 41 receives an inquiry from the content delivery unit 40, the content management unit 41 starts the content management processing shown in FIG. 10, and foremost acquires, from the content management table 45 (FIG. 2), the cache storage flag that is associated with the delivery-requested content (SP60), and determines, based on the acquired cache storage flag, whether the content data of the delivery-requested content is stored in the content cache area 22A of the main storage device 22 (SP61).

When the content management unit 41 obtains an affirmative result in the foregoing determination, the content management unit 41 executes the content viewing history management processing of updating the content viewing history management table 47 as needed (SP62). Details regarding the content viewing history management processing will be described later. Moreover, the content management unit 41 thereafter acquires, from the content management table 45, the address (cache storage location address) of the location where the content data of the delivery-requested content is stored in the content cache area 22A of the main storage device 22, and sets the acquired address as the content storage location (SP66).

Subsequently, the content management unit 41 increments, by 1, the access number stored in the access number column 46B (FIG. 3) of the entry (line) corresponding to the delivery-requested content of the content access trend management table 46. Moreover, the content management unit 41 calculates the user index total value of the respective contents registered in the content access trend management table 46, and updates the respective values of the user index total value column 46C (FIG. 3) in the content access trend management table 46 based on the foregoing calculation result (SP68). Note that, with a user who has just been registered (predetermined time has not elapsed since the registration), since it is difficult to comprehend the access trend of that user, that user may be excluded from the target of calculation upon calculating the user index total value.

Subsequently, the content management unit 41 notifies, to the content delivery unit 40, a message indicating the storage status of the delivery-requested content (here, a message to the effect that the content data of the delivery-requested content is to be stored in the content cache area 22A of the main storage device 22), and the cache storage location address that was set as the storage location of the content data of the delivery-requested content in step SP66 (SP69). The content management unit 41 thereafter ends the content management processing.

Meanwhile, when the content management unit 41 obtains a negative result in the determination of step SP61, the content management unit 41 notifies, to the content storage status determination unit, the content name of the delivery-requested content and the user name of the delivery-requesting user, and instructs the content storage status determination unit 42 to determine the storage status of the delivery-requested content (whether the content data is to be stored in the content cache area 22A of the main storage device 22) (SP63).

Moreover, when the determination result of the storage status of the delivery-requested content is thereafter notified from the content storage status determination unit 42, the content management unit 41 determines whether the foregoing determination result is the determination of storing the delivery-requested content in the content cache area 22A of the main storage device 22 (SP64).

When the content management unit 41 obtains a negative result in the foregoing determination, the content management unit 41 acquires the address (storage destination address) stored in the storage destination column 45F (FIG. 2) of the entry (line) associated with the delivery-requested content of the content management table 45, and sets the acquired storage destination address as the storage location of the delivery-requested content (SP67).

Subsequently, the content management unit 41 updates the content access trend management table 46 in the same manner as described above (SP68), and additionally sends, to the content delivery unit 40, a message indicating the storage status of the delivery-requested content (here, a message to the effect that the content data of the delivery-requested content is not to be stored in the content cache area 22A of the main storage device 22), and the storage destination address that was set as the storage location of the delivery-requested content in step SP67 (SP69). The content management unit 41 thereafter ends the content management processing.

Meanwhile, when the content management unit 41 obtains an affirmative result in the determination of step SP64, the content management unit 41 instructs the cache control unit 43 to execute the cache storage preparation processing which is the preparation for storing the content data of the delivery-requested content in the content cache area 22A of the main storage device 22 (SP65).

Based on the foregoing cache storage preparation processing, a storage location of the content data of the delivery-requested content is allocated in the content cache area 22A of the main storage device 22, and the address (cache storage location address) of that storage location is notified from the cache control unit 43 to the content management unit 41. Consequently, the content management unit 41 sets the cache storage location address notified from the cache control unit 43 as the storage location of the content data of the delivery-requested content (SP66).

Subsequently, the content management unit 41 updates the content access trend management table 46 in the same manner as described above (SP68), and additionally sends, to the content delivery unit 40, a message indicating the storage status of the delivery-requested content (here, a message to the effect that the content data of the delivery-requested content is to be stored in the content cache area 22A of the main storage device 22), and the cache storage location address that was set as the storage location of the content data of the delivery-requested content in step SP66 (SP69).

In other words, in the case of obtaining an affirmative result in step SP64, the delivery-requested content is read from the storage apparatus 6 into the address location of the cache storage location address that was set as the storage location in step SP66 within the content cache area 22A of the main storage device 22, and concurrently read from that address location into the content delivery unit 40 and sent to the client 2.

The content management unit 41 thereafter ends the content management processing.

### (1-5-4) Content Viewing History Management Table Update Processing

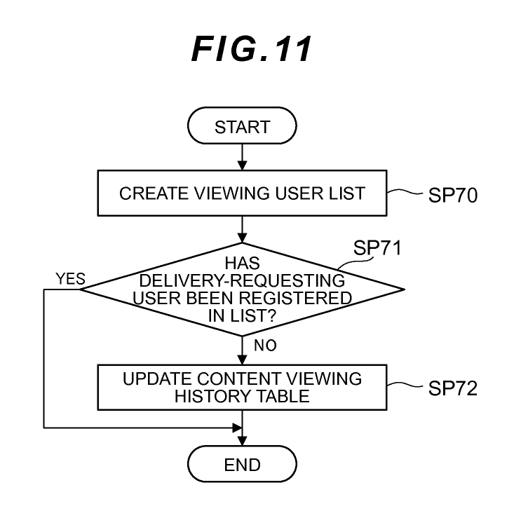

FIG. 11 shows the specific processing routine of the content viewing history management table update processing that is executed by the content management unit 41 in step SP62 of the content management processing described above with reference to FIG. 10.

When the content management unit 41 proceeds to step SP62 of the content management processing, the content management unit 41 starts the content viewing history management table update processing, and foremost acquires the user name of all users who have previously viewed the delivery-requested content from the viewing user name column 47B (FIG. 4) of the entry (line) associated with the delivery-requested content of the content viewing history management table 47, and creates a list (hereinafter referred to as the “viewing user list”) in which the acquired user name of all users is registered (SP70).

Subsequently, the content management unit 41 determines whether the user name of the delivery-requesting user of the delivery-requested content is registered in the viewing user list created in step SP70 (S71P), and, upon obtaining an affirmative result, ends the content viewing history management table update processing.

Meanwhile, when the content management unit 41 obtains an affirmative result in the determination of step SP71, the content management unit 41 updates the content viewing history management table 47 so as to additionally register the user name of the delivery-requesting user of the delivery-requested content in the viewing user name column 47B of the entry associated with the delivery-requested content of the content viewing history management table 47 (SP72), and thereafter ends the content viewing history management table update processing.

### (1-5-5) Content Storage Status Determination Processing

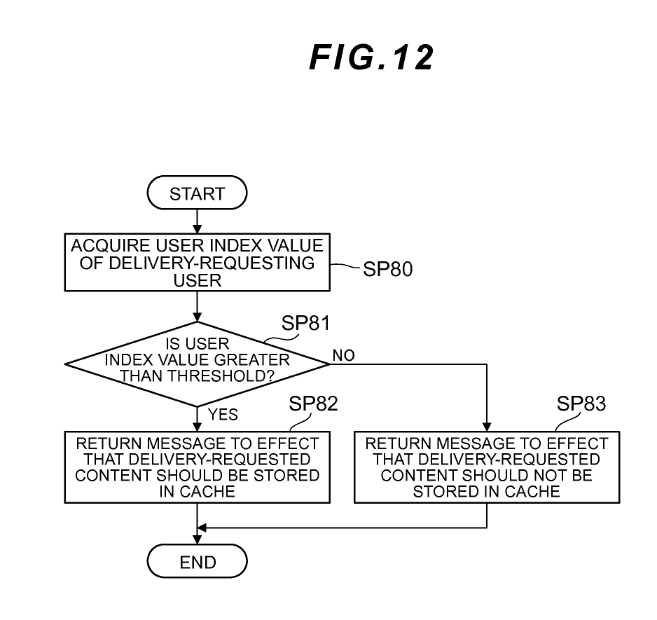

FIG. 12 shows the processing routine of the content storage status determination processing that is executed by the content storage status determination unit 42, which was instructed by the content management unit 41 to determine the storage status of the delivery-requested content in step SP63 of the content management processing described above with reference to FIG. 10. According to the processing routine shown in FIG. 12, the content storage status determination unit 42 determines whether the content data of the delivery-requested content is to be stored in the content cache area 22A of the main storage device 22.

In reality, when the content storage status determination unit 42 receives the foregoing instruction, the content storage status determination unit 42 starts the content storage status determination processing shown in FIG. 12, and foremost acquires the user index value of the delivery-requesting user from the user index management table 48 (SP80).

Subsequently, the content storage status determination unit 42 determines whether the user index value of the delivery-requesting user acquired in step SP80 is greater than a predetermined user index threshold (SP81).

To obtain an affirmative result in the foregoing determination means that the delivery-requesting user is a user who has viewed many popular contents. Accordingly, the content (delivery-requested content) for which the delivery was requested by this kind of delivery-requesting user is expected to become popular in the future and the access number thereof is expected to increase. Consequently, the content storage status determination unit 42 determines that the content data of the delivery-requested content is to be stored in the content cache area 22A of the main storage device 22, and notifies the determination result to the content management unit 41 (SP82). The content storage status determination unit 42 thereafter ends the content storage status determination processing.

Meanwhile, to obtain a negative result in the determination of step SP81 means that the delivery-requesting user is a user who does not view popular contents that much. Accordingly, the content (delivery-requested content) for which the delivery was requested by this kind of delivery-requesting user is not expected to become popular in the future and the access number thereof is not expected to increase. Consequently, the content storage status determination unit 42 determines that the content data of the delivery-requested content is not to be stored in the content cache area 22A of the main storage device 22, and notifies the determination result to the content management unit 41 (SP83). The content storage status determination unit 42 thereafter ends the content storage status determination processing.

### (1-5-6) Cache Storage Preparation Processing

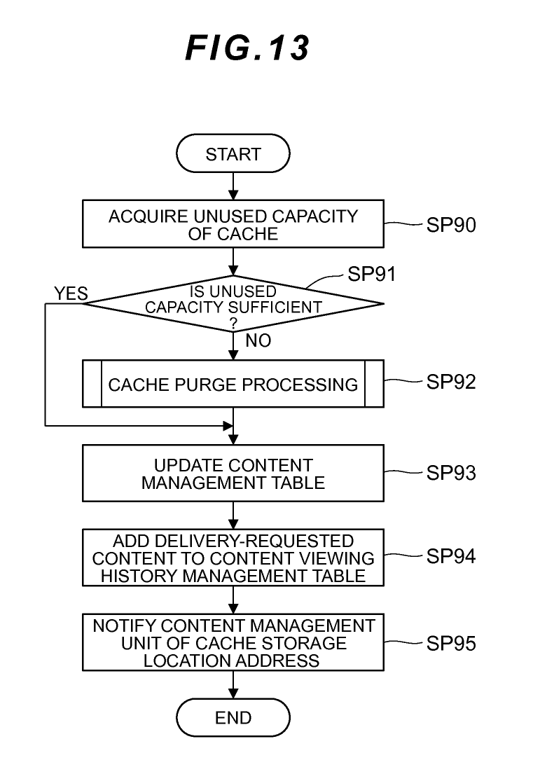

FIG. 13 shows the processing routine of the cache storage preparation processing that is executed by the cache control unit 43, which was instructed to execute the cache storage preparation processing in step SP65 of the content management processing described above with reference to FIG. 10. According to the processing routine of FIG. 13, the cache control unit 43 makes preparations for storing the content data of the delivery-requested content from the content management to the content cache area 22A of the main storage device 22.

In reality, when the cache control unit 43 is given the foregoing instruction, the cache control unit 43 starts the cache storage preparation processing shown in FIG. 13, and foremost refers to the content management table 45, acquires the data size of the respective contents stored in the content cache area 22A of the main storage device 22, compares the total value of the data size of the respective contents and the capacity of the content cache area 22A of the main storage device 22, and thereby acquires the current unused capacity of the content cache area 22A (SP90).

Subsequently, the cache control unit 43 acquires the data size of the delivery-requested content from the content management table 45, and determines whether there is enough unused capacity in the content cache area 22A for storing the content data of the delivery-requested content based on the acquired data size of the delivery-requested content and the unused capacity of the content cache area 22A of the main storage device 22 acquired in step SP90 (SP91).

When the cache control unit 43 obtains an affirmative result in the foregoing determination, the cache control unit 43 proceeds to step SP93. Meanwhile, when the cache control unit 43 obtains a negative result in the foregoing determination, the cache control unit 43 executes the cache purge processing of eliminating (purging) the content data of unneeded contents among the contents in which the content data is stored in the content cache area 22A of the main storage device 22 (SP92). The cache control unit 43 can thereby allocate an unused capacity, which is sufficient for storing the content data of the delivery-requested content, in the content cache area of the main storage device 22.

Subsequently, the cache control unit 43 updates the content management table 45 according to the processing result of the foregoing cache purge processing (SP93). Specifically, the cache control unit 43 changes, from “1” to “0”, the cache storage flag stored in the cache storage flag column 45D (FIG. 2) regarding the entry associated with the content that was purged from the content cache area 22A of the main storage device 22 based on the cache purge processing among the entries (lines) of the content management table 45, and additionally changes the address stored in the cache storage location column 45E (FIGS. 2) to “0”. Moreover, the cache control unit 43 changes, from “0” to “1”, the cache storage flag stored in the cache storage flag column 45D regarding the entry associated with the delivery-requested content among the entries of the content management table 45, and additionally stores, in the cache storage location column 45E, the address of the storage area for storing the content data of the delivery-requested content which was allocated in the content cache area 22A of the main storage device 22 based on the cache purge processing.

Subsequently, the cache control unit 43 adds the entry of the delivery-requested content to the content viewing history management table 47 (SP94). Specifically, the cache control unit 43 stores the content name of the delivery-requested content in the content name column 47A (FIG. 4) in an unused line in the content viewing history management table 47, and additionally stores the user name of the delivery-requesting user in the viewing user name column 47B (FIG. 4) of that line.

Finally, the cache control unit 43 notifies the content management unit 41 of the address (cache storage location address) of the storage area for storing the content data of the delivery-requested content which was allocated in the content cache area 22A of the main storage device 22 based on the cache purge processing of step SP92 (SP95), and thereafter ends the cache storage preparation processing.

### (1-5-7) Cache Purge Processing

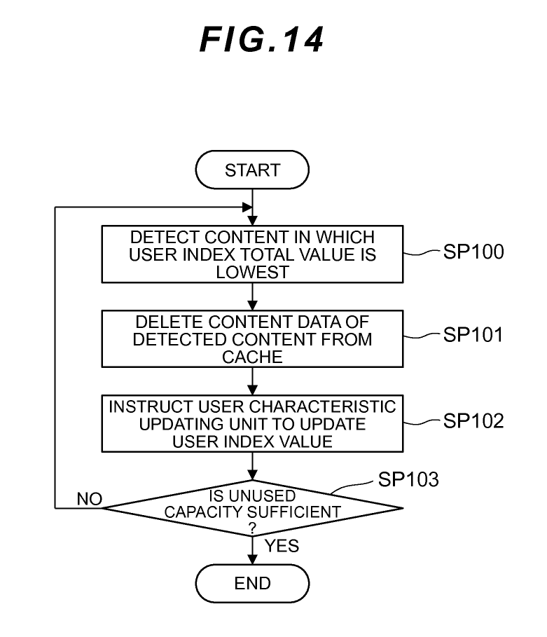

FIG. 14 shows the specific processing routine of the cache purge processing that is executed by the cache control unit 43 in step SP92 of the cache storage preparation processing described above with reference to FIG. 13.

When the cache control unit 43 proceeds to step SP92 of the cache storage preparation processing, the cache control unit 43 starts the cache purge processing shown in FIG. 14, and foremost refers to the content management table 45 and the content access trend management table 46, and then detects the content with the lowest user index total value (hereinafter referred to as the “content to be purged”) among the contents in which the content data is stored in the content cache area 22A of the main storage device 22 (SP100).

Subsequently, the cache control unit 43 purges, from the content cache area 22A of the main storage device 22, the content data of the content to be purged that was detected in step SP100 (SP101). Moreover, the cache control unit 43 instructs the user characteristic updating unit to execute the user characteristic update processing of updating the user index management table 48 according to the processing result of step SP101 (SP102).

Subsequently, in the same manner as with step SP91 of the cache storage preparation processing described above with reference to FIG. 13, the cache control unit 43 determines whether it was possible to allocate, in the content cache area 22A of the main storage device 22, an unused area of a capacity capable of storing the content data of the delivery-requested content (SP103).

When the cache control unit 43 obtains a negative result in the foregoing determination, the cache control unit 43 returns to step SP100, and thereafter repeats the processing of step SP100 to step SP103 until an affirmative result is obtained in step SP103.

When the cache control unit 43 obtains an affirmative result in step SP103 as a result of an unused area of a capacity capable of storing the content data of the delivery-requested content eventually being allocated in the content cache area 22A of the main storage device 22, the cache control unit 43 ends the cache purge processing.

### (1-5-8) User Characteristic Update Processing

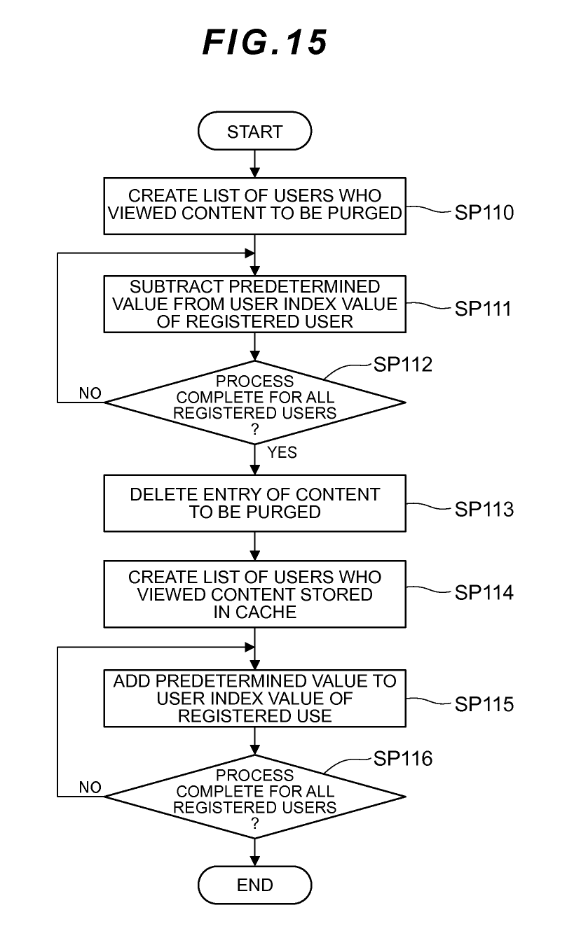

FIG. 15 shows the specific processing routine of the user characteristic update processing that is executed by the user characteristic updating unit 44, which was instructed by the cache control unit 43 to update the user index management table 48 in step SP102 of the cache purge processing described above with reference to FIG. 14.

When the user characteristic updating unit 44 receives the foregoing instruction from the cache control unit 43, the user characteristic updating unit 44 starts the user characteristic update processing, and foremost refers to the content viewing history management table 47, and creates a list of users who have previously viewed the content to be purged (hereinafter referred to as the “content-to-be-purged viewing user list”) (SP110).

Subsequently, the user characteristic updating unit 44 selects one user who is registered in the content-to-be-purged viewing user list, and updates the user index management table 48 so that the user index value of the selected user is changed to a value obtained by subtracting a predetermined value (“2” in this example) therefrom (SP111).

Subsequently, the user characteristic updating unit 44 determines whether the processing of step SP111 has been executed for all users who are registered in the content-to-be-purged viewing user list (SP112). When the user characteristic updating unit 44 obtains a negative result in the foregoing determination, the user characteristic updating unit 44 returns to step SP111, and thereafter repeats the loop of step SP111-step SP112-step SP111 while sequentially switching the user selected in step SP111 to another user who has not yet been processed.

When the user characteristic updating unit 44 obtains an affirmative result in step SP112 as a result of the processing of step SP111 eventually being executed for all users who are registered in the content-to-be-purged viewing user list, the user characteristic updating unit 44 deletes the entry of the content to be purged from the content viewing history management table 47 (SP113). Accordingly, only the contents in which the content data is stored in the content cache area 22A of the main storage device 22 will be registered in the content viewing history management table 47.

Subsequently, the user characteristic updating unit 44 refers to the content viewing history management table 47, and creates a list of users who have viewed, or will view, the content in which the content data is currently stored in the cache (that is, the content registered in the content viewing history management table 47) (hereinafter referred to as the “cache-stored content viewing user list”) (SP114).

Subsequently, the user characteristic updating unit 44 selects one user who is registered in the cache-stored content viewing user list, and updates the user index management table 48 so that the user index value of the selected user is changed to a value obtained by adding a predetermined value (“1” in this example) thereto (SP115).

Subsequently, the user characteristic updating unit 44 determines whether the processing of step SP115 has been executed for all users who are registered in the cache-stored content viewing user list (SP116). When the user characteristic updating unit 44 obtains a negative result in the foregoing determination, the user characteristic updating unit 44 returns to step SP115, and thereafter repeats the loop of step SP115-step SP116-step SP115 while sequentially switching the user selected in step SP115 to another user who has not yet been processed.

When the user characteristic updating unit 44 obtains an affirmative result in step SP116 as a result of the processing of step SP115 eventually being executed for all users who are registered in the cache-stored content viewing user list, the user characteristic updating unit 44 ends the user characteristic update processing.

### (1-6) Effect of the Present Embodiment

With the content delivery system 1 of the present embodiment having the configuration described above, the content data of contents viewed by users having a high user index value can be preferentially stored in the content cache area 22A of the main storage device 22 of the content management server 4.

In addition, since the access number of the contents viewed by users having a high user index value is expected to increase in the future, by retaining the content data of those contents in the content cache area 22A, it is possible to improve the probability (cache hit rate) of reading the content data from the content cache area 22A.

Moreover, since the access number of the contents viewed by users having a low user index value is not expected to increase in the future, by not storing the content data of these contents in the content cache area 22A, it is possible to prevent the wasteful use of the content cache area 22A.

Accordingly, the content delivery system 1 can improve the utilization efficiency of the content cache area 22A of the main storage device 22 of the content management server 4.

### (2) Second Embodiment

### (2-1) Configuration of Content Delivery System According to the Present Embodiment

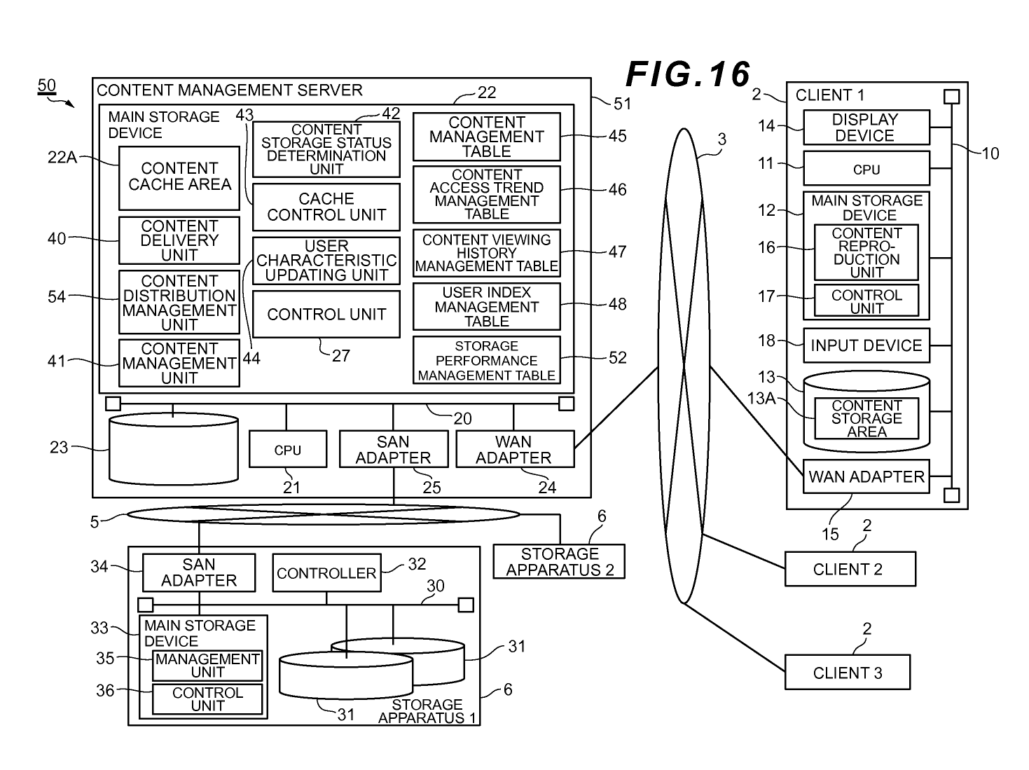

FIG. 16 shows a content delivery system 50 according to the second embodiment. In FIG. 16, since components that are given the same reference numeral as those in FIG. 1 have the same configuration and function as the corresponding components of FIG. 1, the explanation thereof is omitted in the present embodiment. Accordingly, in the ensuing explanation, the features of the content delivery system 50 according to the present embodiment that differ from the first embodiment are explained.

The content delivery system 50 according to the present embodiment differs considerably from the content management system 1 according to the first embodiment with respect to the point that each type of storage device 31 (SAS disk, SATA disk or the like) mounted on the respective storage apparatuses 6 is different, and thus the performance of each storage apparatus 6 is different.

In addition, the content delivery system 50 periodically executes the hierarchy control processing, based on the control of the content management server 51, of relocating (migrating) the content data of a content with a high access frequency to a storage apparatus 6 with a high response performance as needed, and relocating (migrating) the content data of a content with a low access frequency to a storage apparatus 6 with a low response performance as needed, in accordance with the access frequency to the content.

Meanwhile, upon purging the content to be purged from the content cache area 22A of the main storage device 22 of the content management server 51, when it is necessary to determine whether to relocate the content data of the content to be purged and then relocate the content data, if the content data of the content to be purged is transferred to the storage apparatus 6 of the relocation destination, it is considered that the overhead required for relocating the content data can be reduced in comparison to the case of sending and receiving the content data of the content to be relocated between the storage apparatuses 6.

Thus, one feature of the content delivery system 50 according to the present embodiment is that the relocation of content data is also executed as needed upon purging the content to be purged from the content cache area 22A of the main storage device 22 of the content management server 51.

As means for realizing the foregoing content management function according to the present embodiment, the main storage device 22 of the content management server 51 according to the present embodiment stores a content distribution management unit 54 as a program module in addition to the content delivery unit 40, the content management unit 65, the content storage status determination unit 64, the cache control unit 43, the user characteristic updating unit 44 and the control unit 27, and stores a storage performance management table 52 as a management table in addition to the content management table 45, the content access trend management table 46, the content viewing history management table 47 and the user index management table 48.

The content distribution management unit 54 is a module for determining the relocation destination of the content to be purged from the content cache area 22A of the main storage device 22 and performing control for the relocation of the content.

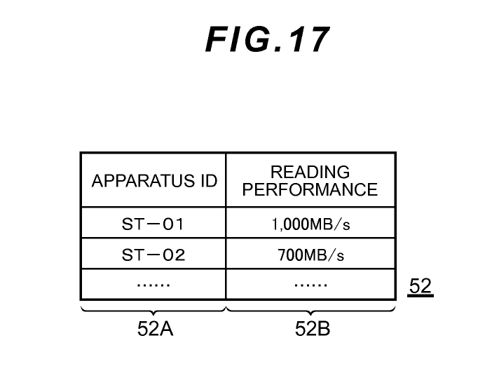

Moreover, the storage performance management table 52 is a table that is used for managing the performance of the respective storage apparatuses 6, and is configured from, as shown in FIG. 17, an apparatus ID column 52A and a reading performance column 52B.

The apparatus ID column 52A stores the apparatus ID of the respective storage apparatuses 6 existing within the content delivery system 50, and the reading performance column 52B stores the theoretical value of the data read rate of the corresponding storage apparatus 6.

Accordingly, FIG. 17 shows a case where the theoretical value of the data read rate of the storage apparatus 6 having an apparatus ID of “ST-01” is “1000 MB/s”, and the theoretical value of the data read rate of the storage apparatus 6 having an apparatus ID of “ST-02” is “700 MB/s”.

### (2-2) Cache Purge Processing According to the Present Embodiment

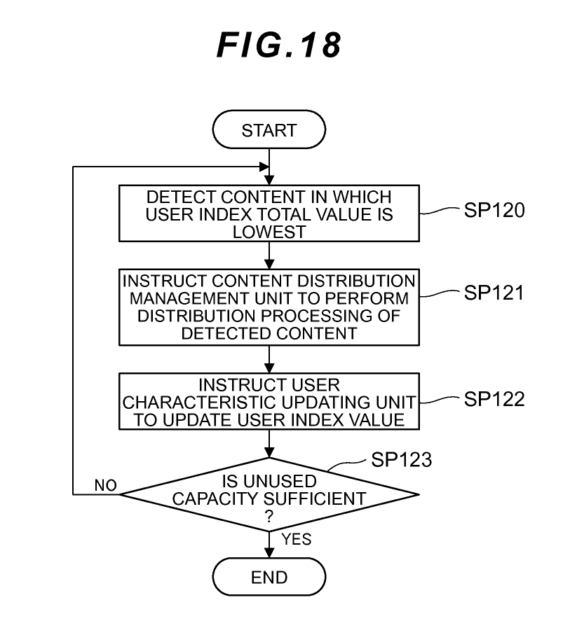

The cache control unit 53 of the present embodiment executes the cache storage preparation processing described above with reference to FIG. 13 under the same conditions as the cache control unit 43 of the first embodiment, but in step SP92 of this cache storage preparation processing, the cache purge processing shown in FIG. 18 is executed in substitute for the cache purge processing according to the first embodiment described above with reference to FIG. 14.

In other words, when the cache control unit 53 proceeds to step SP92 of the cache storage preparation processing, the cache control unit 53 starts the cache purge processing shown in FIG. 18, and foremost refers to the content management table 45 and the content access trend management table 46, and detects the content (content to be purged) with the lowest user index total value among the contents in which the content data is stored in the content cache area 22A of the main storage device 22 (SP120).

Subsequently, the cache control unit 53 instructs the content distribution management unit 54 to execute the content distribution processing of relocating (migrating) the content data of the content to be purged, which was detected in step SP120, to an appropriate storage apparatus 6 as needed (SP121).

Subsequently, the cache control unit 53 instructs the user characteristic updating unit 44 to execute the user characteristic update processing of updating the user index management table 48 according to the processing result of the content distribution processing (SP122). Based on the foregoing instruction, the user characteristic updating unit 44 executes the same user characteristic update processing as the first embodiment described above with reference to FIG. 15.

Subsequently, in the same manner as step SP91 of the cache storage preparation processing described above with reference to FIG. 13, the cache control unit 53 determines whether it was possible to allocate, in the content cache area 22A of the main storage device 22, an unused area of a capacity capable of storing the content data of the delivery-requested content (SP123).

When the cache control unit 53 obtains a negative result in the foregoing determination, the cache control unit 53 returns to step SP120, and thereafter repeats the processing of step SP120 to step SP123 until an affirmative result is obtained in step SP123.

When the cache control unit 53 obtains an affirmative result in step SP123 as a result of an unused area of a capacity capable of storing the content data of the delivery-requested content eventually being allocated in the content cache area 22A of the main storage device 22, the cache control unit 53 ends the cache purge processing.

### (2-3) Content Distribution Processing

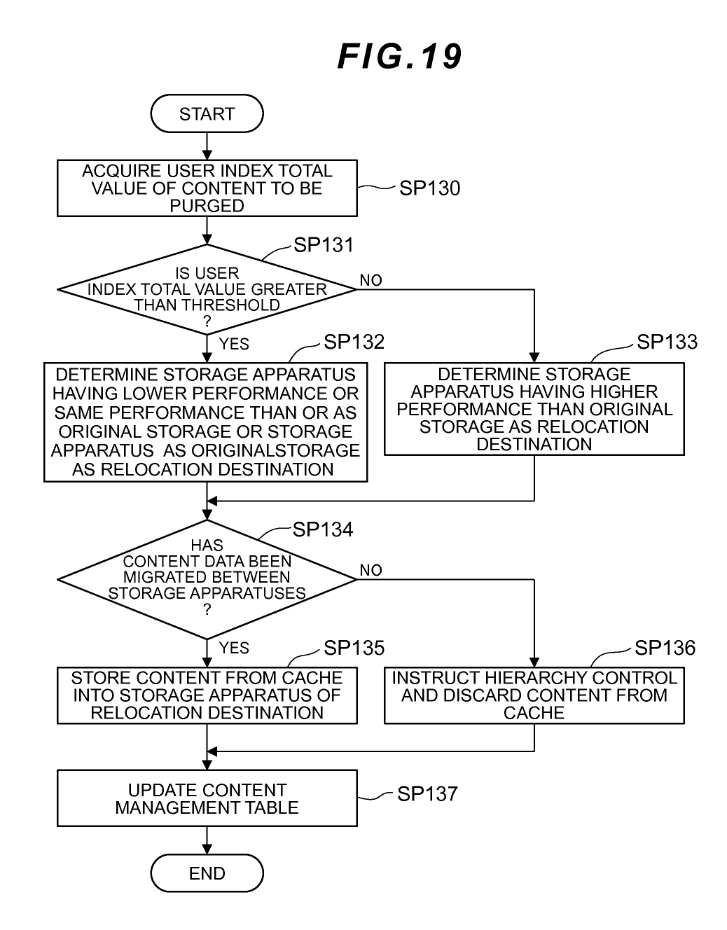

FIG. 19 shows the processing routine of the content distribution processing that is executed by the content distribution management unit 54, which was instructed by the cache control unit 53 to execute the content distribution processing in step SP121 of the cache purge processing described above with reference to FIG. 18.

When the content distribution management unit 54 receives the foregoing execution instruction, the content distribution management unit 54 starts the content distribution processing shown in FIG. 19, and foremost refers to the content access trend management table 46, and acquires the user index total value of the content to be purged (SP130). Moreover, the content distribution management unit 54 thereafter determines whether the value of the acquired user index total value is greater than a predetermined relocation threshold (SP131).

When the content distribution management unit 54 obtains an affirmative result in the foregoing determination, the content distribution management unit 54 refers to the storage performance management table 52, and determines the storage apparatus (hereinafter referred to as the “data-storing storage apparatus”) 6 that is currently storing the content data of the content to be purged or the storage apparatus 6 with a lower performance (slower read rate) than the data-storing storage apparatus 6 as the relocation destination of the content data of the content to be purged (SP132).

Meanwhile, when the content distribution management unit 54 obtains a negative result in the determination of step SP131, the content distribution management unit 54 refers to the storage performance management table 52, and determines the storage apparatus 6 with a higher performance (faster read rate) than the data-storing storage apparatus 6 as the relocation destination of the content data of the content to be purged (SP133).

Subsequently, the content distribution management unit 54 determines whether the migration of data between the storage apparatuses 6 is required for migrating the content data from the data-storing storage apparatus 6 to the storage apparatus (hereinafter referred to as the “relocation destination storage apparatus”) 6 that was set as the relocation destination of the content data of the content to be purged in step SP132 or step SP133 (that is, whether the data-storing storage apparatus 6 and the relocation destination storage apparatus 6 are different storage apparatuses) (SP134).

When the content distribution management unit 54 obtains an affirmative result in the foregoing determination, the content distribution management unit 54 reads the content data of the content to be purged from the content cache area 22A of the main storage device 22, and sends the read content data to the relocation destination storage apparatus 6 together with a write request. Moreover, the content distribution management unit 54 concurrently instructs the data-storing storage apparatus 6 to purge the content data of the content to be purged (SP135).

Consequently, the content data of the content to be purged is stored in the relocation destination storage apparatus 6, the content data of the content to be purged is purged from the data-storing storage apparatus 6, and the migration of the content data of the content to be purged from the data-storing storage apparatus 6 to the relocation destination storage apparatus 6 is thereby completed.

Meanwhile, when the content distribution management unit 54 obtains a negative result in the determination of step SP134, the content distribution management unit 54 instructs the controller 32 (FIG. 1) of the data-storing storage apparatus 6 to execute the hierarchy control processing, and additionally purges the content data of the content to be purged from the content cache area 22A of the main storage device 22 (SP136). Accordingly, in the foregoing case, the content data of the content to be purged is not migrated from the data-storing storage apparatus 6 to the relocation destination storage apparatus 6.

The content distribution management unit 54 thereafter updates the storage destination column of the entry associated with the content to be purged in the content management table 45 to new information as needed (SP137), and thereafter ends the content distribution processing.

### (2-4) Effect of the Present Embodiment

With the content delivery system 50 of the present embodiment having the configuration described above, upon purging the content data of a content from the content cache area 22A of the main storage device 22 of the content management server 51, the content data of the content is relocated to a storage apparatus 6 having an appropriate performance according to the access number of the content.

Accordingly, the content delivery system 50 can reduce the number of contents to be relocated during the hierarchy control processing, and consequently reduce the overhead required for relocating the content data by that much.

### (3) Third embodiment

In the first embodiment, the user index value was used as the factor for determining whether to store the content data of a content in the content cache area 22A of the main storage device 22 of the content management server 4 (storage status of the content). Meanwhile, one feature of the present embodiment is that the storage status of the content is determined by additionally giving consideration to the period that the access number to each content reaches a peak (hereinafter referred to as the “peak access period”). The content delivery system according to the present embodiment is now explained.

### (3-1) Configuration of Content Delivery System According to the Present Embodiment

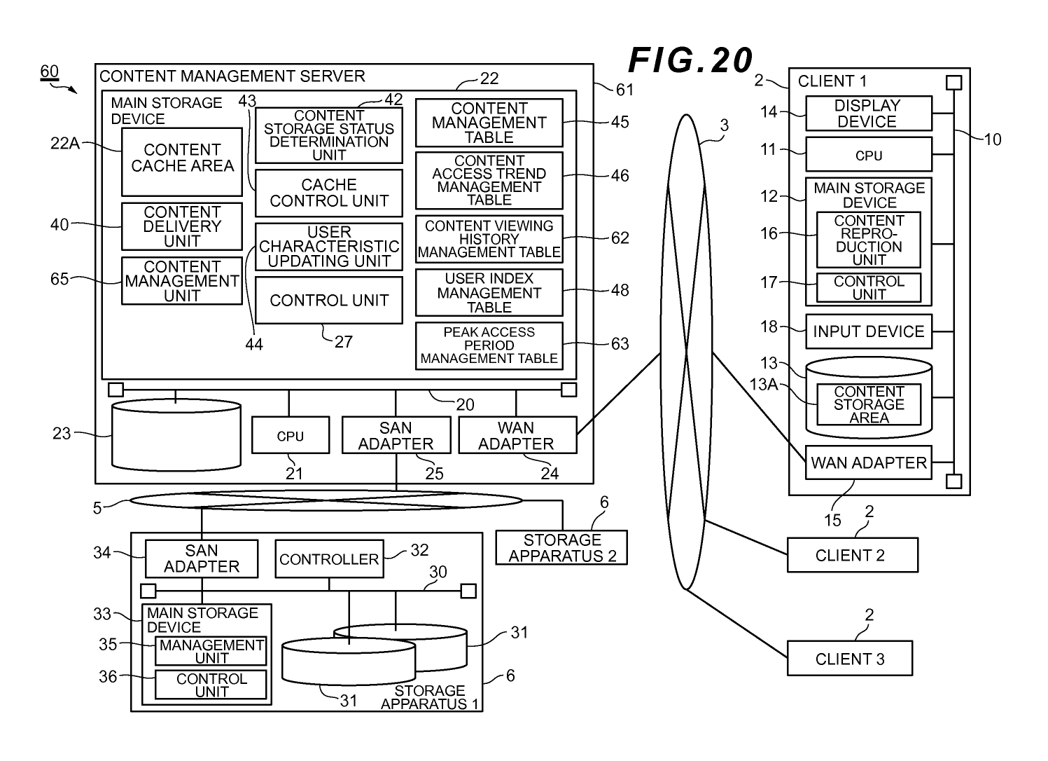

FIG. 20, in which the same reference numeral is given to the components corresponding to those of FIG. 1, shows a content delivery system 60 according to the third embodiment. The content delivery system 60 is configured in the same manner as the content delivery system 1 according to the first embodiment excluding the following points; namely, the configuration of the content viewing history management table 62 is different, a content peak access period management table 63 is stored in the main storage device 22 of the content management server 61, and a part of the processing contents of the content storage status determination processing that is executed by the content storage status determination unit 64 is different.

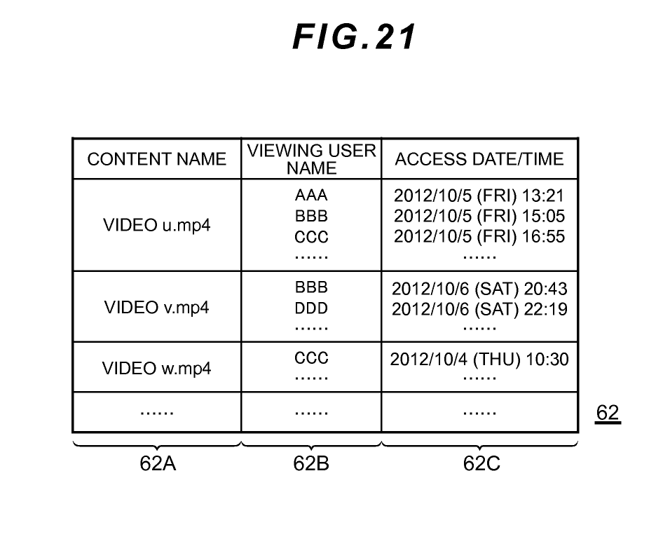

FIG. 21 shows the configuration of the content viewing history management table 62 according to the present embodiment. The content viewing history management table 62 is configured from a content name column 62A, a viewing user name column 62B and an access date/time column 62C.

The content name column 62A and the viewing user name column 62B respectively store the same information as the content viewing history management table 47 of the first embodiment described above with reference to FIG. 4.

Moreover, the access date/time column 62C stores the date/time and day of week (hereinafter referred to as the “content access date/time”) that the content delivery request was sent by the corresponding user for the corresponding content. The content access date/time is registered or updated by the content management unit 65 when the content management server 61 receives the content delivery request from the corresponding user for the corresponding content.

Accordingly, FIG. 21 shows a case where, while the content named “video u.mp4” is stored in the content cache area 22A of the main storage device 22 of the content management server 61, a content delivery request for the content was sent from the users named “AAA”, “BBB”, “CCC”, . . . to the content management server 61, and, for example, the date/time that the content delivery request was received from the user named “AAA” was “2012/10/5 13:21”, and the day of week was “Friday”.

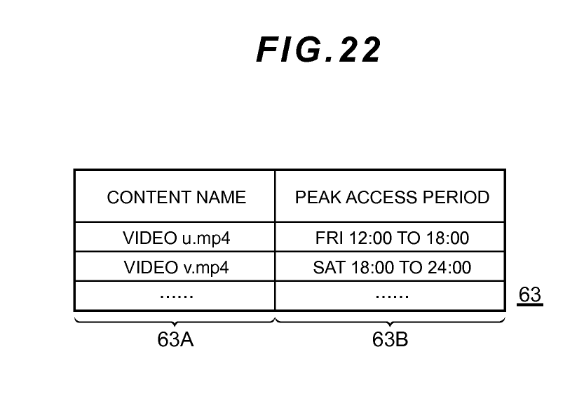

Meanwhile, the content peak access period management table 63 is a table that is used for managing the peak access period of the respective contents, and is configured from, as shown in FIG. 22, a content name column 63A and a peak access period column 63B. The content name column 63A stores the content name of the respective contents that are being managed by the content management server 61, and the peak access period column 63B stores the peak access period of the corresponding content.

Accordingly, FIG. 22 shows a case where the peak access period of the content named “video u.mp4” is “12:00 to 18:00” on “Friday”, and the peak access period of the content named “video v.mp4” is “18:00 to 24:00” on “Saturday”.

Note that the content peak access period management table 63 is periodically updated by the content management unit 65 (for instance, every 6 hours).

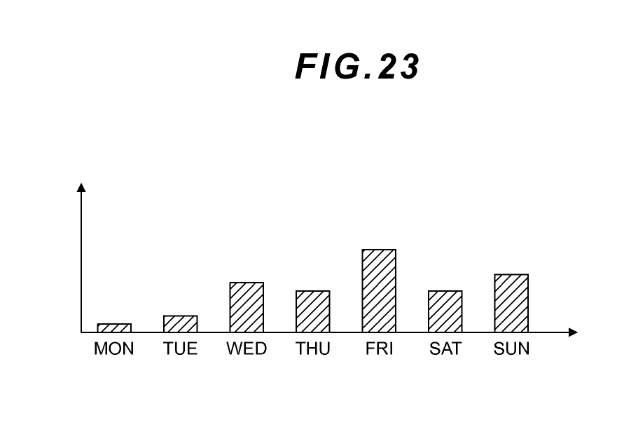

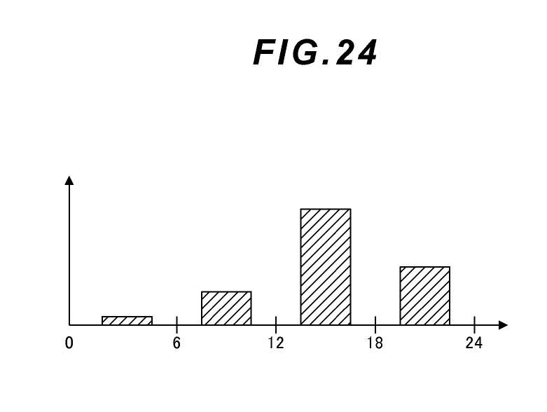

In reality, the content management unit 65 periodically refers to the content viewing history management table 62, and creates a histogram of the access number of each content for each day of week of the content within a predetermined period (for instance, 1 month) as shown in FIG. 23. Moreover, the content management unit 65 concurrently creates, for each content, a histogram of the access number for each time period within the same period as shown in FIG. 24.

Subsequently, based on the histogram of the access number for each day of week and the histogram of the access number for each time period created for each content as described above, the content management unit 65 acquires the day of week of each content in which the access number to the content becomes maximum and the time period of each content in which the access number to the content becomes maximum in the course of a day, and registers the peak access period in the peak access period column 63B of the corresponding entry of the content peak access period management table 63 or updates the peak access period stored in the peak access period column 63B based on the foregoing acquisition result.

For example, in the examples shown in FIG. 23 and FIG. 24, the day of week in which the access number of the corresponding content (“video u.mp4” in this example) becomes maximum is “Friday”, and the time period in which the access number of the content becomes maximum is “12:00 to 18:00”. Thus, the content management unit 65 updates the peak access period column 63B of the entry corresponding to “video u.mp4” in the content peak access period management table 63 to “Friday, 12:00 to 18:00” as show in FIG. 22.

### (3-2) Content Storage Status Determination Processing According to the Present Embodiment

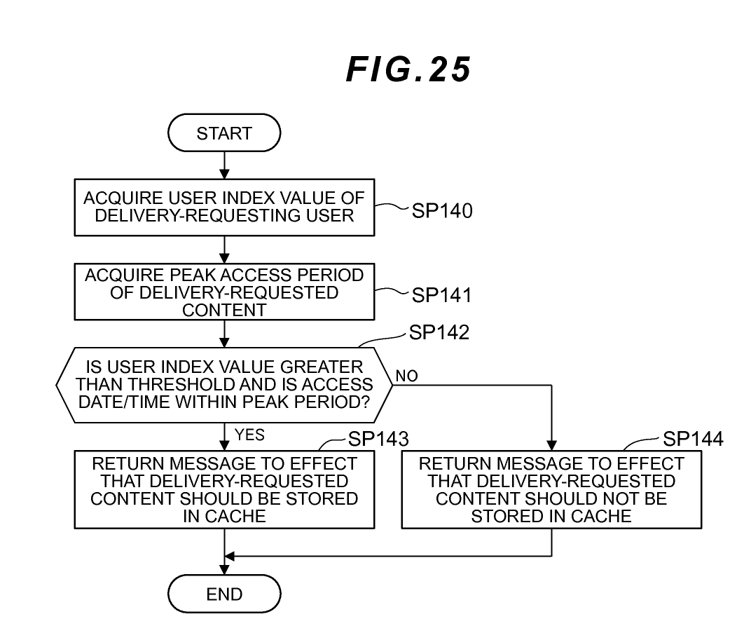

FIG. 25 shows the content storage status determination processing according to the present embodiment that is executed by the content storage status determination unit 64 in substitute for the content storage status determination processing described above with reference to FIG. 12. The content storage status determination unit 64 determines whether the content data of the delivery-requested content is to be stored in the content cache area 22A of the main storage device 22 according to the processing routine shown in FIG. 12.

In reality, the content storage status determination unit 64 is instructed by the content management unit 41 to determine the storage status of the delivery-requested content in step SP63 of the content management processing described above with reference to FIG. 10, the content storage status determination unit 64 starts the content storage status determination processing shown in FIG. 25, and foremost acquires the user index value of the delivery-requesting user from the user index management table 48 (SP140).

Subsequently, the content storage status determination unit 64 refers to the content peak access period management table 63, and acquires the peak access period of the delivery-requested content (SP141).

Subsequently, the content storage status determination unit 64 determines whether the user index value of the delivery-requesting user acquired in step SP140 is greater than a predetermined user index threshold, and whether the time that the content delivery request was received by the content management server is during the peak access period of the delivery-requested content acquired in step SP141 (SP142).

When the content storage status determination unit 64 obtains an affirmative result in the foregoing determination, the content storage status determination unit 64 determines that the content data of the delivery-requested content is to be stored in the content cache area 22A of the main storage device 22, and notifies the determination result to the content management unit 65 (SP143). The content storage status determination unit 64 thereafter ends the content storage status determination processing.

Meanwhile, when the content storage status determination unit 64 obtains a negative result in the determination of step SP142, the content storage status determination unit 64 determines that the content data of the delivery-requested content is not to be stored in the content cache area 22A of the main storage device 22, and notifies the determination result to the content management unit 41 (SP144). The content storage status determination unit 64 thereafter ends the content storage status determination processing.

### (3-3) Effect of the Present Embodiment

With the content delivery system 60 of the present embodiment having the configuration described above, even when the user index value of the delivery-requesting user is higher than the user index threshold, the content data of the delivery-requested content will not be stored in the content cache area 22A of the main storage device 22 unless the content management server 61 receives the content delivery request during the peak access period of the delivery-requested content (refer to step SP142 of FIG. 25).

Accordingly, the content delivery system 60 can inhibit the content data of the delivery-requested content from being stored in the content cache area 22A of the main storage device 22 during periods other than the peak access period. Consequently, it is possible to prevent unneeded content data from being stored in the content cache area 22A of the main storage device 22, and improve the utilization efficiency of the content cache area 22A.

### (4) Other Embodiments

The foregoing first to third embodiments described cases of applying the present invention to the content delivery systems 1, 50, 60 respectively configured as shown in FIG. 1, FIG. 16 or FIG. 20, but the present invention is not limited thereto, and various other configurations may be broadly applied as the configuration of the content delivery system to which the present invention is applied.

Moreover, the foregoing first to third embodiments described cases where, in the user characteristic update processing described above with reference to FIG. 15, 2 is subtracted from the user index value of each user who previously viewed the content to be purged from the content cache area 22A of the main storage device 22 and 1 is added to the user index value of each user who have viewed, or will view, the content remaining in the content cache area 22A, the present invention is not limited thereto, and the value to be subtracted from or added to the user index value may be other values.

In addition, the foregoing first to third embodiments described cases of configuring, from the CPU 21 of the content management servers 4, 51, 61 and the various program modules stored in the main storage device 22, the control unit for determining the content in which the content data is to be stored the content cache area 22A of the main storage device 22 and the content in which data is to be purged from the content cache area 22A based on the user characteristic of each user obtained based on the viewing history of the content of each user using the respective clients 2 and the content characteristic of each content that is extracted from information associated with the content, the present invention is not limited thereto, and, for example, the control unit may also be configured from dedicated hardware.

Furthermore, the foregoing third embodiment described a case of storing the content data of the delivery-requested content in the content cache area 22A of the main storage device 22 when the user index value of the delivery-requesting user is greater than a predetermined user index threshold and when the time that the content delivery request was received by the content management server 61 is during the peak access period of the delivery-requested content, the present invention is not limited thereto, and, for example, in step SP142 of the content storage status determination processing described above with reference to FIG. 25, it is also possible to determine whether the time that the content delivery request was received by the content management server 61 is within a time period that is a prescribed time (for instance, 1 to 2 hours) after the start of the peak access period of the delivery-requested content and up to the end of the peak access period. Based on the foregoing determination, the content data of the delivery-requested content can be stored in the content cache area 22A of the main storage device 22 before the peak access period of the delivery-requested content, and the delivery-requested content can be delivered to the client more quickly during the peak access period of the delivery-requested content.

Note that the present invention is not limited to the foregoing first to third embodiments, and also includes various modified examples. For example, the foregoing first to third embodiments offered a detailed explanation for facilitating the understanding of the present invention, but the present invention is not necessarily limited to the configuration comprising all of the explained components. Moreover, a certain configuration of a certain embodiment may be substituted with a configuration of another embodiment, and a configuration of a certain embodiment may also be added to the configuration of another embodiment. Moreover, a part of a configuration of the respective embodiments may be added to, deleted from or substituted with another configuration.

Moreover, the respective configurations, functions, processing units, processing means and the like described above may also be realized via hardware by designing a part or the whole thereof with, for example, an integrated circuit. Moreover, the respective configurations, functions and the like described above may also be realized via software by the processor interpreting and executing the programs for realizing the respective functions. Information such as programs, tables, files and the like for realizing the respective functions may be stored in a memory, a hard disk device, a storage device such as an SSD, or stored in a storage medium such as an SD (Secure Digital) card or a DVD-ROM (Digital Versatile Disc-Read Only Memory).

### REFERENCE SIGNS LIST

1, 50, 60 . . . content delivery system, 2 . . . client, 4, 51, 61 . . . content management server, 6 . . . storage apparatus, 21 . . . CPU, 22 . . . main storage device 22A . . . content cache area, 31 . . . storage device, 32 . . . controller, 40 . . . content delivery unit, 41, 65 . . . content management unit, 42, 64 . . . content storage status determination unit, 43 . . . cache control unit, 44 . . . user characteristic updating unit, 45 . . . content management table, 46 . . . content access trend management table, 47, 62 . . . content viewing history management table, 48 . . . user index management table, 52 . . . storage performance management table, 63 . . . peak access period management table.

1. A content management apparatus which manages one or more contents to be delivered in which data is stored in a storage apparatus and, in accordance with a delivery request from a client, delivers the delivery-requested content to the client, comprising:
a cache for temporarily storing data of the content; and
a control unit for determining the content in which data is to be stored in the cache and the content in which data is to be purged from the cache based on a user characteristic of each user obtained based on a viewing history of the content of each user using each of the clients, and a content characteristic of each of the contents extracted from information associated with the content.

2. The content management apparatus according to claim 1,
wherein the control unit:
manages, as the user characteristic of each user, a user index value of each user, in which a first numerical value is subtracted for a user who has previously viewed the content and in which a predetermined second numerical value is added for a user who has previously viewed or will view the content in which data is remaining in the cache, upon purging data of the content from the cache; and
determines, when a delivery request of the content is received from the client and data of the content is not stored in the cache, whether to store data of the content in the cache based on the user index value of a user who operated the client.

3. The content management apparatus according to claim 2,
wherein the control unit manages, as the content characteristic of each of the contents, a user index total value obtained by totaling the user index value of each user who has previously viewed the content, and determines the content in which data is to be purged from the cache based on the user index total value of each of the contents in which data is stored in the cache.

4. The content management apparatus according to claim 3,
wherein a plurality of storage apparatuses having a different performance from each other are provided, and
wherein the control unit:
periodically executes relocation processing of controlling the corresponding storage apparatus so that a content with a higher access frequency is relocated to the storage apparatus with a higher performance; and
determines, after determining the content in which data is to be purged from the cache, the storage apparatus which should be a relocation destination of data of the content based on the user index total value, and controls the corresponding storage apparatus as needed for relocating data of the content to the storage apparatus.

5. The content management apparatus according to claim 2,
wherein the control unit:
manages, for each of the contents, a peak accesses period in which an access number to the content reaches a peak; and
determines, when a delivery request of the content is received from the client and data of the content is not stored in the cache, whether to store data of the content in the cache based on the user index value of the user who operated the client and a reception date/time of the delivery request of the content relative to the peak access period of the content.

6. A content management method of managing one or more contents to be delivered in a content management apparatus which manages one or more contents to be delivered in which data is stored in a storage apparatus and, in accordance with a delivery request from a client, delivers the delivery-requested content to the requesting client,
wherein the content management apparatus includes:
a cache for temporarily storing data of the content; and
a control unit for determining the content in which data is to be stored in the cache and the content in which data is to be purged from the cache,
wherein the content management method comprises:
a first step whereby the control unit respectively manages a viewing history of the content of each user using each of the clients, and a content characteristic of each of the contents which is extracted from information associated with the content; and
a second step whereby the control unit determines the content in which data is to be stored in the cache and the content in which data is to be purged from the cache, based on the user characteristic of each user and the content characteristic of each of the contents.

7. The content management method according to claim 6,
wherein, in the first step, the control unit manages, as the user characteristic of each user, a user index value of each user in which a first numerical value is subtracted for a user who has previously viewed the content, and in which a predetermined second numerical value is added for a user who has previously viewed or will view the content in which data is remaining in the cache, upon purging data of the content from the cache; and
wherein, in the second step, the control unit determines, when a delivery request of the content is received from the client and data of the content is not stored in the cache, whether to store data of the content in the cache based on the user index value of the user who operated the client.

8. The content management method according to claim 7,
wherein, in the first step, the control unit manages, as the content characteristic of each of the contents, a user index total value obtained by totaling the user index value of each user who has previously viewed the content; and
wherein, in the second step, the control unit determines the content in which data is to be purged from the cache based on the user index total value of each of the contents in which data is stored in the cache.

9. The content management method according to claim 8,
wherein a plurality of storage apparatuses having a different performance from each other are provided, and
wherein the control unit periodically executes relocation processing of controlling the corresponding storage apparatus so that a content with a higher access frequency is relocated to the storage apparatus with a higher performance; and
wherein, in the second step, the control unit determines, after determining the content in which data is to be purged from the cache, the storage apparatus which should be a relocation destination of data of the content based on the user index total value, and controls the corresponding storage apparatus as needed for relocating the data of the content to the storage apparatus.

10. The content management method according to claim 7,
wherein the control unit manages, for each of the contents, a peak accesses period in which an access number to the content reaches a peak; and
wherein, in the second step, the control unit determines, when a delivery request of the content is received from the client and data of the content is not stored in the cache, whether to store data of the content in the cache based on the user index value of the user who operated the client and a reception date/time of the delivery request of the content relative to the peak access period of the content.

11. A storage medium storing a program to be installed in a content management apparatus which manages one or more contents to be delivered in which data is stored in a storage apparatus and, in accordance with a delivery request from a client, delivers the delivery-requested content to the requesting client, wherein the content management apparatus includes:
a cache for temporarily storing data of the content; and
a control unit for determining the content in which data is to be stored in the cache and the content in which data is to be purged from the cache,
wherein the program causes the control unit to execute:
a first step of respectively managing a viewing history of the content of each user using each of the clients, and a content characteristic of each of the contents which is extracted from information associated with the content; and
a second step of determining the content in which data is to be stored in the cache and the content in which data is to be purged from the cache based on the user characteristic of each user and the content characteristic of each of the contents.

12. The storage medium according to claim 11,
wherein, in the first step, the control unit manages, as the user characteristic of each user, a user index value of each user in which a first numerical value is subtracted for a user who has previously viewed the content and in which a predetermined second numerical value is added for a user who has previously viewed or will view the content in which data is remaining in the cache, upon purging data of the content from the cache; and
wherein, in the second step, the control unit determines, when a delivery request of the content is received from the client and data of the content is not stored in the cache, whether to store data of the content in the cache based on the user index value of the user who operated the client.

13. The storage medium according to claim 12,
wherein, in the first step, the control unit manages, as the content characteristic of each of the contents, a user index total value obtained by totaling the user index value of each user who has previously viewed the content; and
wherein, in the second step, the control unit determines the content in which data is to be purged from the cache based on the user index total value of each of the contents in which data is stored in the cache.

14. The storage medium according to claim 13,
wherein a plurality of storage apparatuses having a different performance from each other are provided, and
wherein the control unit periodically executes relocation processing of controlling the corresponding storage apparatus so that a content with a higher access frequency is relocated to the storage apparatus with a higher performance; and
wherein, in the second step, the control unit determines, after determining the content in which data is to be purged from the cache, the storage apparatus to become a relocation destination of data of the content based on the user index total value, and controls the corresponding storage apparatus as needed for relocating the data of the content to the storage apparatus.

15. The storage medium according to claim 12,
wherein the control unit manages, for each of the contents, a peak accesses period in which an access number to the content reaches a peak; and
wherein, in the second step, the control unit determines, when a delivery request of the content is received from the client and data of the content is not stored in the cache, whether to store data of the content in the cache based on the user index value of the user who operated the client and a reception date/time of the delivery request of the content relative to the peak access period of the content.
